(19) United States
(12) Patent Application Publication
(10) Pub. No.: US 2025/0356864 A1
(43) Pub. Date: Nov. 20, 2025

(54) AUDIO ENCODING METHOD AND APPARATUS, AUDIO DECODING METHOD AND APPARATUS, DEVICE, AND STORAGE MEDIUM

(71) Applicant: Tencent Technology (Shenzhen) Company Limited, Shenzhen (CN)

(72) Inventors: Wei XIAO, Shenzhen (CN); Wenzhen Liu, Shenzhen (CN); Meng Wang, Shenzhen (CN); Shidong Shang, Shenzhen (CN)

(21) Appl. No.: 19/281,197

(22) Filed: Jul. 25, 2025

Related U.S. Application Data
(63) Continuation of application No. PCT/CN2024/091202, filed on May 6, 2024.

(30) Foreign Application Priority Data
May 24, 2023 (CN) 202310597138.3

(51) Int. Cl. G10L 19/02; G10L 25/21

(52) U.S. Cl. CPC G10L 19/0204; G10L 25/21

(57) ABSTRACT

This application provides an audio encoding method performed by an electronic device. The method includes: performing down-sampling on an audio signal to obtain a low-frequency signal of the audio signal and low-frequency feature extraction on the low-frequency signal to obtain a low-frequency feature of the audio signal; performing high-frequency analysis on the audio signal to obtain a high-frequency feature of the audio signal, a feature dimension of the high-frequency feature being lower than a feature dimension of the low-frequency feature; performing encoding on the low-frequency feature and the high-frequency feature to obtain a low-frequency code stream of the audio signal and a high-frequency code stream of the audio signal; and transmitting the low-frequency code stream of the audio signal and the high-frequency code stream of the audio signal to a second electronic device via a computer network.

### CROSS-REFERENCE TO RELATED APPLICATIONS

This application is a continuation application of PCT Patent Application No. PCT/CN2024/091202, entitled “AUDIO ENCODING METHOD AND APPARATUS, AUDIO DECODING METHOD AND APPARATUS, DEVICE, AND STORAGE MEDIUM” filed on May 6, 2024, which claims priority to Chinese Patent Application No. 202310597138.3, entitled “AUDIO ENCODING METHOD AND APPARATUS, AUDIO DECODING METHOD AND APPARATUS, DEVICE, AND STORAGE MEDIUM” filed on May 24, 2023, both of which are incorporated herein by reference in their entirety.

### FIELD OF THE TECHNOLOGY

This application relates to artificial intelligence (AI) technologies, and in particular, to an audio encoding method and apparatus, an audio decoding method and apparatus, a device, and a storage medium.

### BACKGROUND OF THE DISCLOSURE

Artificial intelligence (AI) is a comprehensive technology of computer science, which studies design principles and implementation methods of various intelligent machines, to enable machines to have functions of sensing, reasoning, and decision-making. An AI technology is a comprehensive discipline, and relates to a wide range of fields, for example, several major directions such as natural language processing technologies and machine learning (ML)/deep learning (DL). With the development of technologies, the AI technology is applied to more fields, and plays an increasingly important value.

An audio encoding and decoding technology is one of important applications in the field of AI. The audio encoding and decoding technology is a core technology in communication services including remote audio/video calling. In simple terms, the voice encoding technology is to transfer voice information as much as possible by using relatively few network bandwidth resources. From a perspective of the Shannon information theory, voice encoding is source encoding. An objective of the source encoding is to compress, to the greatest extent, data volume of information that is intended to transfer on an encoder side, remove redundancy in the information, and restore the information losslessly (or nearly losslessly) on a decoder side.

In the related art, to ensure audio quality, efficiency of audio encoding is greatly reduced during encoding.

### SUMMARY

Embodiments of this application provide an audio encoding method and apparatus, an audio decoding method and apparatus, an electronic device, a non-transitory computer-readable storage medium, and a computer program product, which can improve audio coding efficiency while ensuring audio quality.

Technical solutions in the embodiments of this application are implemented as follows.

An embodiment of this application provides an audio encoding method, the method including:
performing down-sampling on an audio signal to obtain a low-frequency signal of the audio signal;
performing low-frequency feature extraction on the low-frequency signal to obtain a low-frequency feature of the audio signal;
performing high-frequency analysis on the audio signal to obtain a high-frequency feature of the audio signal; and
performing encoding on the low-frequency feature and the high-frequency feature separately to obtain a low-frequency code stream of the audio signal and a high-frequency code stream of the audio signal; and
transmitting the low-frequency code stream of the audio signal and the high-frequency code stream of the audio signal to a second electronic device via a computer network.

An embodiment of this application provides an electronic device, including:
a memory, configured to store a computer program or a computer-executable instruction; and
a processor, configured to implement the audio encoding method provided in the embodiments of this application when executing the computer program or the computer-executable instruction stored in the memory.

An embodiment of this application provides a non-transitory computer-readable storage medium storing a video bitstream that is generated by the aforementioned audio encoding method provided in the embodiments of this application.

The embodiments of this application have the following beneficial effects.

The audio signal is down-sampled to obtain the low-frequency signal. Because the low-frequency signal has more impact on audio encoding than the high-frequency signal in the audio signal, the low-frequency feature and the high-frequency feature of the audio signal are respectively extracted through differential signal processing, so that the feature dimension of the high-frequency feature is lower than the feature dimension of the low-frequency feature, and the low-frequency feature and the high-frequency feature whose feature dimensions are reduced are respectively encoded, thereby improving audio encoding efficiency while ensuring audio quality.

### BRIEF DESCRIPTION OF THE DRAWINGS

FIG. 1 is a schematic diagram of a spectrum comparison at different bit rates according to an embodiment of this application.

FIG. 2 is a schematic architectural diagram of an audio encoding and decoding system according to an embodiment of this application.

FIG. 3A and FIG. 3B are schematic structural diagrams of an electronic device according to an embodiment of this application.

FIG. 4A is a schematic diagram of a general convolutional network according to an embodiment of this application.

FIG. 4B is a schematic diagram of a dilated convolutional network (a dilated CNN) according to an embodiment of this application.

FIG. 5 is a schematic diagram of a band extension according to an embodiment of this application.

FIG. 6A is a first schematic flowchart of an audio encoding method according to an embodiment of this application.

FIG. 6B is a second schematic flowchart of an audio encoding method according to an embodiment of this application.

FIG. 6C is a third schematic flowchart of an audio encoding method according to an embodiment of this application.

FIG. 6D is a fourth schematic flowchart of an audio encoding method according to an embodiment of this application.

FIG. 7A is a first schematic flowchart of an audio decoding method according to an embodiment of this application.

FIG. 7B is a second schematic flowchart of an audio decoding method according to an embodiment of this application.

FIG. 7C is a third schematic flowchart of an audio decoding method according to an embodiment of this application.

FIG. 7D is a fourth schematic flowchart of an audio decoding method according to an embodiment of this application.

FIG. 8 is a schematic diagram of an end-to-end voice communication link according to an embodiment of this application.

FIG. 9 is a schematic flowchart of a low-rate neural network (NN) encoding and decoding method according to an embodiment of this application.

FIG. 10 is a schematic diagram of a first NN according to an embodiment of this application.

FIG. 11 is a schematic diagram of a second NN according to an embodiment of this application.

### DESCRIPTION OF EMBODIMENTS

To make objectives, technical solutions, and advantages of this application clearer, this application is described in further detail with reference to drawings. The described embodiments are not to be construed as a limitation on this application. All other embodiments obtained by a person of ordinary skill in the art without creative efforts fall within the protection scope of this application.

In the following description, a term “first/second” involved is merely configured for distinguishing between similar objects and does not represent a specific order of objects. “First/second” may be transposed for a specific order or a sequence when allowed, so that the embodiments of this application described herein can be implemented in an order other than those illustrated or described herein.

In the following description, a term “some embodiments” involved describes subsets of all possible embodiments, but it may be understood that “some embodiments” may be the same subset or different subsets of all the possible embodiments, and may be combined with each other without conflict.

Unless otherwise defined, meanings of all technical and scientific terms used in this specification are the same as those usually understood by a person skilled in the art to which this application belongs. The terms used in this specification are merely intended to describe objectives of the embodiments of this application, and are not intended to limit this application.

Before the embodiments of this application are further described in detail, a description is provided on nouns and terms in the embodiments of this application, and the nouns and terms in the embodiments of this application are applicable to the following explanations.

1) Neural network (NN): It is an algorithm mathematics model for imitating behavior features of an animal NN to perform distributed parallel information processing. This network depends on complexity of a system, and implements information processing by adjusting connection relationships between a large quantity of internal nodes.

2) Deep learning (DL): It is a new research direction in the field of machine learning (ML). DL is to learn an internal law and a representation level of sample data, and the information obtained during the learning is of great help to interpretation of data such as text, an image, and a sound. An ultimate goal of DL is to enable a machine to have analysis and learning capabilities like a person and recognize the data such as the text, the image, and the sound.

3) Quantization: It refers to a process of approximating continuous values (or a large number of discrete values) of a signal to a limited number of (or fewer) discrete values. Quantization includes vector quantization (VQ) and scalar quantization.

The VQ is an effective lossy compression technology, and a theoretical basis thereof is Shannon's rate-distortion theory. A basic principle of the VQ is to replace an input vector with an index of a codeword most matching an input vector in a codebook for transmission and storage, and only a simple table look-up operation is needed during decoding. For example, a plurality of pieces of scalar data is formed into a vector space, the vector space is divided into a plurality of small areas, and during quantization, a vector falling into a small area is replaced with a corresponding index for an input vector.

The scalar quantization is to perform quantization on a scalar, i.e., one-dimensional VQ. A dynamic range is divided into several small intervals, and each small interval has a representative value (i.e., an index). When the input signal falls within a certain interval, the input signal is quantized into the representative value.

4) Entropy coding: A lossless encoding manner in which no information is lost based on an entropy principle during encoding is also a key module in lossy encoding, and is located at an end of an encoder. Entropy coding includes Shannon coding, Huffman coding, Exp-Golomb coding, and arithmetic coding.

The voice encoding technology is to transfer voice information as much as possible by using relatively few network bandwidth resources. A compression rate of a voice codec may reach more than 10 times, i.e., after voice data of original 10 MB is compressed by an encoder, only 1 MB is needed for transmission, which greatly reduces bandwidth resources consumed for information transmission. For example, for a wideband voice signal whose sampling rate is 16000 Hz, if a 16-bit sampling depth (fineness of voice strength recording in sampling) is used, a bit rate (a transmitted data volume per unit time) of an uncompressed version is 256 kbps. If a voice encoding technology is used, even if lossy encoding is used, in a bit rate range of 10-20 kbps, quality of a reconstructed voice signal may approach an uncompressed version, and even it is considered that the voice signal is not different from the uncompressed version in hearing sense. If a service with a higher sampling rate is needed, for example, an ultra-wideband voice of 32000 Hz, the bit rate range at least reaches above 30 kbps.

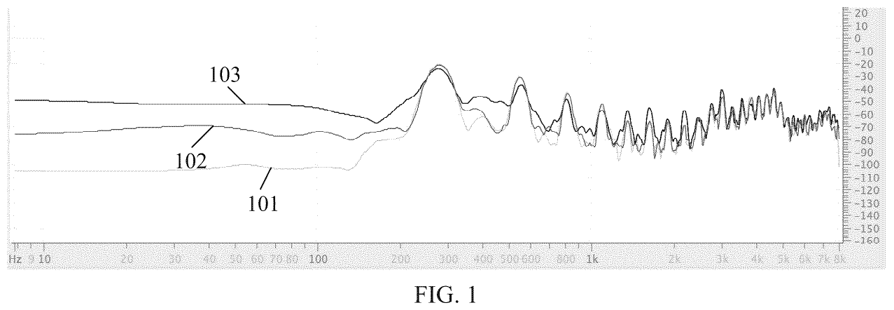

In a communication system, to ensure successful communication, standard voice encoding and decoding protocols are deployed within the industry, for example, standards from international domestic standard organizations such as ITU-T, 3GPP, IETF, AVS, and CCSA, G.711, G.722 AMR series, EVS, and OPUS. FIG. 1 is a schematic diagram of a spectrum comparison at different bit rates, to demonstrate a relationship between a compressed bit rate and quality. A curve 101 is a spectrum curve of an original voice, i.e., a signal without compression. A curve 102 is a spectrum curve of an OPUS encoder at a bit rate of 20 kbps. A curve 103 is a spectrum curve of an OPUS encoder at a bit rate of 6 kbps. It may be learned from FIG. 1 that with an increase of an encoding bit rate, a compressed signal is closer to an original signal.

In the related art, principles of voice encoding are substantially as follows. The voice encoding may directly encode voice waveform samples one by one. Alternatively, related low-dimensional features are extracted based on a human vocalizing principle, the features are encoded on an encoder side, and a voice signal is reconstructed on a decoder side based on the parameters.

The foregoing encoding principles come from voice signal modeling, i.e., a signal processing-based compression method, and audio encoding quality cannot be ensured. To improve audio encoding efficiency while ensuring voice quality, embodiments of this application provide an audio encoding method and apparatus, an audio decoding method and apparatus, an electronic device, a non-transitory computer-readable storage medium, and a computer program product based on AI. An exemplary application of the electronic device provided in the embodiments of this application is described below. The electronic device provided in the embodiments of this application may be implemented as a terminal device, or collaboratively implemented by a terminal device and a server. A description is provided below by using an example in which the electronic device is implemented as the terminal device.

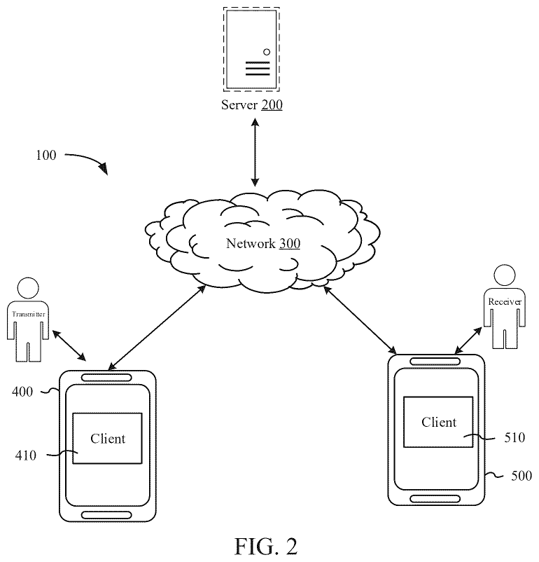

Exemplarily, FIG. 2 is a schematic architectural diagram of an audio encoding and decoding system 10 according to an embodiment of this application. The audio encoding and decoding system 10 includes a server 200, a network 300, a terminal device 400 (i.e., an encoder side) and a terminal device 500 (i.e., a decoder side). The network 300 may be a local area network or a wide area network, or a combination thereof.

In some embodiments, a client 410 runs on the terminal device 400, and the client 410 may be various types of clients, such as an instant messaging client, a network conference client, a live client, or a browser. In response to an audio collection instruction triggered by a transmitter (for example, an initiator of an online conference, an anchor, or an initiator of a voice call), the client 410 invokes a microphone built in the terminal device 400 to collect an audio signal, and performs audio encoding processing on the collected audio signal, to obtain code streams (a high-frequency code stream and a low-frequency code stream).

For example, the client 410 invokes the audio encoding method provided in the embodiments of this application to encode the collected audio signal, i.e., performing down-sampling processing on an audio signal, to obtain a low-frequency signal of the audio signal; performing low-frequency feature extraction processing on the low-frequency signal to obtain a low-frequency feature of the audio signal; performing high-frequency analysis processing on the audio signal to obtain a high-frequency feature of the audio signal, a feature dimension of the high-frequency feature being lower than a feature dimension of the low-frequency feature; and performing encoding processing on the low-frequency feature to obtain a low-frequency code stream of the audio signal, and performing encoding processing on the high-frequency feature to obtain a high-frequency code stream of the audio signal. The encoder side (i.e., the terminal device 400) combines a signal processing technology and the AI technology to down-sample the audio signal, to obtain a low-frequency signal. Because the low-frequency signal has more impact on audio encoding than a high-frequency signal in the audio signal, a low-frequency feature and a high-frequency feature of the audio signal are respectively extracted through differential signal processing, so that the feature dimension of the high-frequency feature is lower than the feature dimension of the low-frequency feature, and the low-frequency feature and the high-frequency feature whose feature dimensions are reduced are respectively encoded, thereby improving audio encoding efficiency while ensuring audio quality.

The client 410 may transmit the code streams (i.e., the high-frequency code stream and the low-frequency code stream) of the audio signal to the server 200 through the network 300, so that the server 200 transmits the code streams (the high-frequency code stream and the low-frequency code stream) to the terminal device 500 associated with a receiver (for example, a participant of a network conference, a viewer, or a receiver of a voice call).

The client 510 (such as an instant messaging client, a network conference client, a live client, or a browser) running on the terminal device 500 may perform audio decoding processing on the code streams after receiving the code streams (the high-frequency code stream and the low-frequency code stream) transmitted by the server 200, to obtain an audio signal (i.e., a synthesized audio signal), thereby realizing audio communication.

For example, the client 510 invokes the audio decoding method provided in the embodiments of this application to decode the received code streams (the high-frequency code stream and the low-frequency code stream), i.e., performing decoding processing on a low-frequency code stream of an audio signal to obtain a low-frequency feature corresponding to the low-frequency code stream, and performing decoding processing on a high-frequency code stream of the audio signal to obtain a high-frequency feature corresponding to the high-frequency code stream; performing low-frequency feature reconstruction processing on the low-frequency feature to obtain a low-frequency signal corresponding to the low-frequency feature; performing up-sampling processing on the low-frequency signal to obtain an up-sampling signal of the low-frequency signal; and performing signal reconstruction processing on the high-frequency feature and the up-sampling signal to obtain a synthesized audio signal corresponding to the low-frequency code stream and the high-frequency code stream.

In some embodiments, this embodiment of this application may be implemented through a cloud technology. The cloud technology is a hosting technology that unifies a series of resources such as hardware, software, and a network in a wide area network or a local area network to realize data computing, storage, processing, and sharing.

The cloud technology is a generic term of a network technology, an information technology, an integration technology, a management platform technology, and an application technology based on application of a cloud computing business model. The resources may form a resource pool and are used on demand, which is flexible and convenient. A cloud computing technology becomes an important support. A service interaction function between the foregoing servers 200 may be implemented through the cloud technology.

For example, the server 200 shown in FIG. 2 may be an independent physical server, or may be a server cluster formed by a plurality of physical servers or a distributed system, or may be a cloud server providing basic cloud computing services such as a cloud service, a cloud database, cloud computing, a cloud function, cloud storage, a network service, cloud communication, a middleware service, a domain name service, a security service, a content delivery network (CDN), and a big data and AI platform. The terminal device 400 and terminal device 500 shown in FIG. 2 may be various types of user terminals, such as a laptop, a tablet computer, a desktop computer, a set-top box, a mobile device (for example, a mobile phone, a portable music player, a personal digital assistant, a dedicated messaging device, a portable gaming device, an on-board device), a smart phone, a smart speaker, a smart watch, a smart television, and an on-board terminal, but is not limited thereto. The terminal device (for example, the terminal device 400 and the terminal device 500) and the server 200 may be directly or indirectly connected through wired or wireless communication, which is not limited in this embodiment of this application.

In some embodiments, the terminal device or the server 200 may also implement the audio encoding method or the audio decoding method provided in the embodiments of this application by running a computer program. For example, the computer program may be an original program or a software module in an operating system; or may be a native application (APP), i.e., a program that needs to be installed in the operating system to run, such as a live streaming APP, an online conference APP, or an instant messaging APP; or may be an applet that can be embedded into any APP, i.e., a program that only needs to be downloaded into a browser environment to run. In a word, the foregoing computer program may be an APP, a module, or a plug-in of any form.

In some embodiments, a plurality of servers may form a blockchain. The server 200 is a node on the blockchain, each node of the blockchain may have information connection, and information transmission may be performed between nodes through the information connection. Data (for example, audio encoding logic, audio decoding logic, a high-frequency code stream, and a low-frequency code stream) related to the audio encoding method or the audio decoding method provided in the embodiments of this application may be stored on the blockchain.

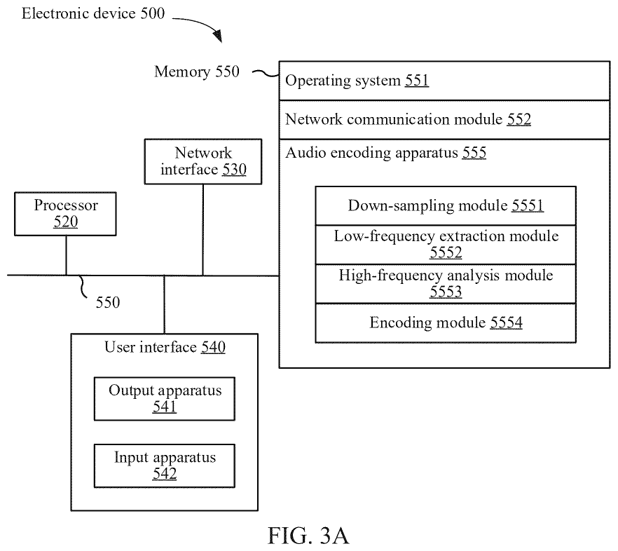

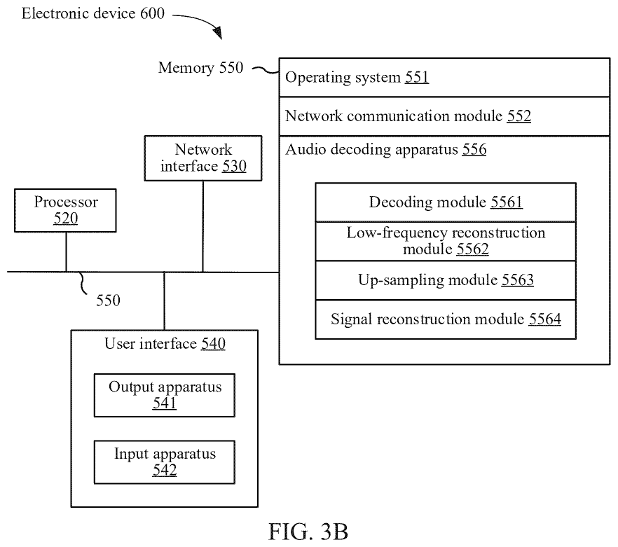

FIG. 3A is a schematic structural diagram of an electronic device 500 according to an embodiment of this application. A description is provided by using an example in which the electronic device 500 is a terminal device. The electronic device 500 shown in FIG. 3A includes at least one processor 520, a memory 550, at least one network interface 530, and a user interface 540. Various assemblies in the electronic device 500 are coupled together through a bus system 550. The bus system 550 is configured to implement connection and communication between the assemblies. In addition to a data bus, the bus system 550 also includes a power bus, a control bus, and a status signal bus. However, for clarity of description, all types of buses in FIG. 3A are marked as the bus system 550.

The processor 520 may be an integrated circuit chip with a signal processing capability, for example, a general-purpose processor, a digital signal processor (DSP), another programmable logic device, a discrete gate or a transistor logic device, or a discrete hardware component. The general-purpose processor may be a microprocessor, any conventional processor, or the like.

The user interface 540 includes one or more output apparatuses 541 that enable presentation of media content, including one or more speakers and/or one or more visual display screens. The user interface 540 further includes one or more input apparatuses 542, including user interface components that facilitate user input, such as a keyboard, a mouse, a microphone, a touch screen display, a camera, and another input button and control.

The memory 550 is removable, non-removable, or a combination thereof. An exemplary hardware device includes a solid-state memory, a hard disk drive, an optical disk drive, and the like. In some embodiments, the memory 550 includes one or more storage devices physically away from the processor 520.

The memory 550 includes a volatile memory or a non-volatile memory, or may include both a volatile memory and a non-volatile memory. The non-volatile memory may be a read-only memory (ROM), and the volatile memory may be a random access memory (RAM). The memory 550 described in this embodiment of this application is intended to include any suitable type of memory.

In some embodiments, the memory 550 can store data to support various operations. Examples of the data include a program, a module, and a data structure or a subset or a superset thereof. An exemplary description is provided below.

An operating system 551 includes system programs configured to process various basic system services and perform hardware-related tasks, for example, a framework layer, a core library layer, and a driver layer, which are configured for implementing various basic services and process hardware-based tasks.

A network communication module 552 is configured to reach another computing device through one or more (wired or wireless) network interfaces 530. An exemplary network interface 530 includes a Bluetooth interface, a wireless compatibility authentication (Wi-Fi) interface, a universal serial bus (USB) interface, and the like.

In some embodiments, the audio encoding apparatus or the audio decoding apparatus provided in the embodiments of this application may be implemented by software. FIG. 3A shows an audio encoding apparatus 555 stored in the memory 550, which may be software in the form of a program, a plug-in, and the like, and include the following software modules: a down-sampling module 5551, a low-frequency extraction module 5552, a high-frequency analysis module 5553, and an encoding module 5554. The down-sampling module 5551, the low-frequency extraction module 5552, the high-frequency analysis module 5553, and the encoding module 5554 are configured to implement audio encoding function. These modules are logical. Therefore, the modules may be combined or further split based on functions to be implemented by the modules.

FIG. 3B is a schematic structural diagram of an electronic device 600 according to an embodiment of this application. A structure of the electronic device 600 is similar to that of an electronic device 500. The electronic device 600 shown in FIG. 3B includes at least one processor 520, a memory 550, at least one network interface 530, and a user interface 540. Various assemblies in the electronic device 500 are coupled together through a bus system 550.

The user interface 540 includes one or more output apparatuses 541 that enable presentation of media content. The user interface 540 further includes one or more input apparatuses 542.

In some embodiments, the memory 550 can store data to support various operations. Examples of the data include a program, a module, and a data structure or a subset or a superset thereof. An exemplary description is provided below.

An operating system 551 includes system programs configured to process various basic system services and perform hardware-related tasks, for example, a framework layer, a core library layer, and a driver layer, which are configured for implementing various basic services and process hardware-based tasks.

A network communication module 552 is configured to reach another computing device through one or more (wired or wireless) network interfaces 530. An exemplary network interface 530 includes a Bluetooth interface, a Wi-Fi interface, a USB interface, and the like.

FIG. 3B shows an audio decoding apparatus 556 stored in the memory 550, which may be software in the form of a program, a plug-in, and the like, including the following software modules: a decoding module 5561, a low-frequency reconstruction module 5562, an up-sampling module 5563, and a signal reconstruction module 5564. The decoding module 5561, the low-frequency reconstruction module 5562, the up-sampling module 5563, and the signal reconstruction module 5564 are configured to implement an audio decoding function. These modules are logical. Therefore, the modules may be combined or further split based on functions to be implemented by the modules.

Before specifically describing the audio encoding method and the audio decoding method provided in the embodiments of this application, a dilated convolutional network (a dilated CNN) and a band extension technology are first described below.

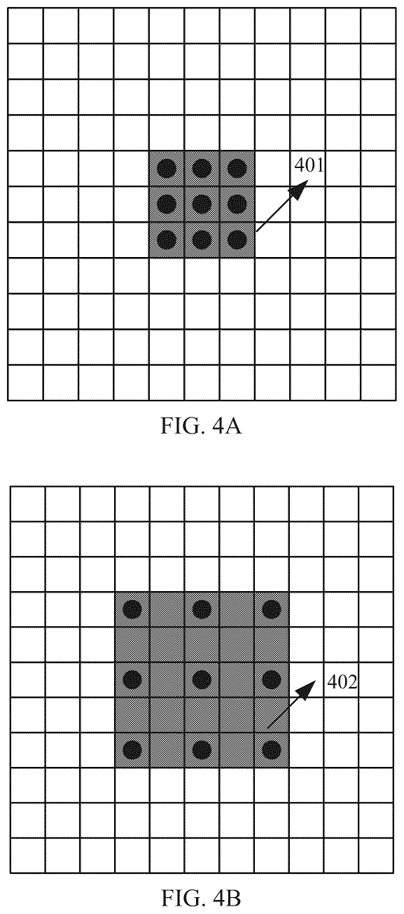

FIG. 4A is a schematic diagram of a general convolutional network according to an embodiment of this application. FIG. 4B is a schematic diagram of a dilated CNN according to an embodiment of this application. Compared with a general convolutional network, a dilated convolution can increase a receptive field while keeping a size of a feature map unchanged, and can further avoid an error caused by up-sampling and down-sampling. Although convolution kernel sizes shown in FIG. 4A and FIG. 4B are both 3×3, the receptive field 401 of the general convolution shown in FIG. 4A is only 3, and the receptive field 402 of the dilated convolution shown in FIG. 4B reaches 5. In other words, for the convolution kernel with a size of 3×3, a receptive field of the general convolution shown in FIG. 4A is 3, and a dilation rate (a quantity of intervals of points in the convolution kernel) is 1. However, a receptive field of the dilated convolution shown in FIG. 4B is 5, and a dilation rate is 2.

The convolution kernel may alternatively move on a plane similar to that in FIG. 4A or FIG. 4B. A concept of a stride rate (step size) is involved herein. For example, each time the convolution kernel is shifted by 1 grid, the corresponding stride rate is 1.

In addition, there is a concept of a number of convolution channels, which refers to a number of convolution kernels corresponding to the parameters configured for convolution analysis. Theoretically, a larger number of channels indicates a more comprehensive signal analysis and higher precision. However, a larger channel indicates higher complexity. For example, for a tensor of 1×320, 24 channels can be configured to perform the convolution operation, and a tensor of 24×320 is outputted.

A size of a dilated convolution kernel (for example, for a voice signal, the size of the convolution kernel can be set to 1×3), a dilation rate, a stride rate, and a number of channels can be defined based on an actual application need, which are not specifically limited in the embodiment of this application.

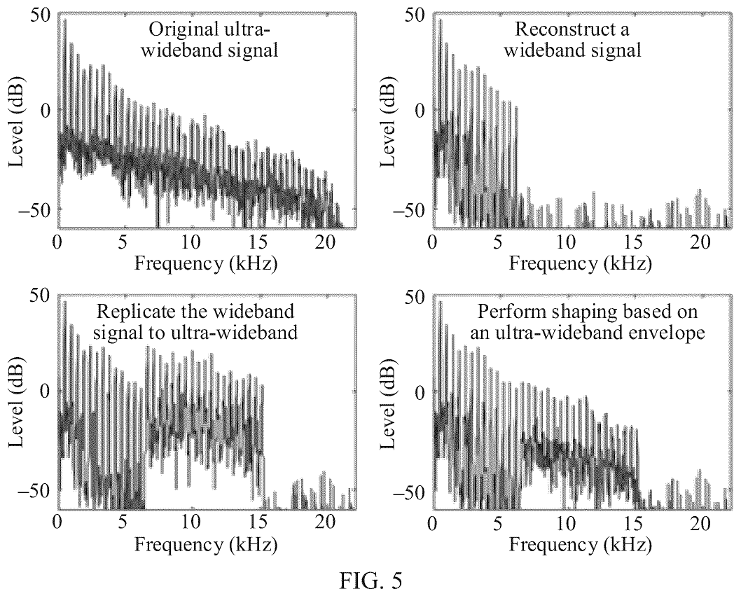

As shown in a schematic diagram of a band extension (or a band replication) in FIG. 5, a wideband signal is first reconstructed, then a wideband signal is replicated to an ultra-wideband signal, and finally, reshaping is performed based on an ultra-wideband envelope. A frequency domain implementation solution shown in FIG. 5 specifically includes: 1) implementing core layer encoding at a low sampling rate; 2) selecting a spectrum of a low-frequency part and replicate the spectrum to a high-frequency; and 3) performing gain control on the replicated high-frequency spectrum based on boundary information (describing an energy correlation between a high-frequency and a low-frequency, and the like) recorded in advance. The sampling rate can be doubled by using only a bit rate of 1-2 kbps.

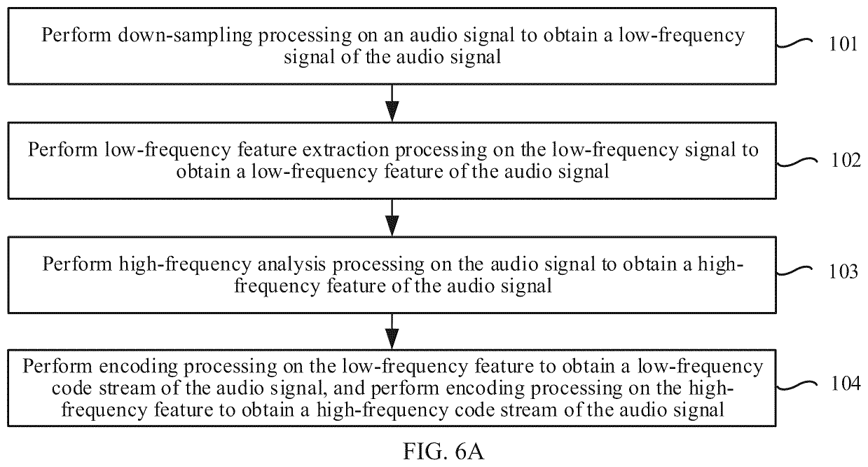

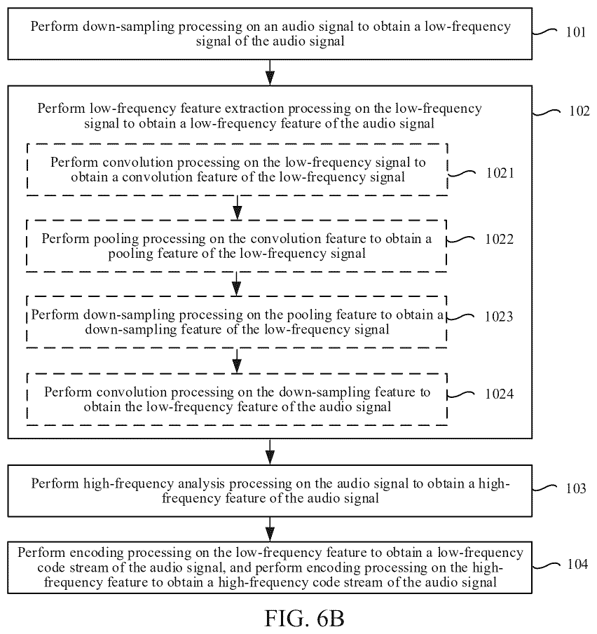

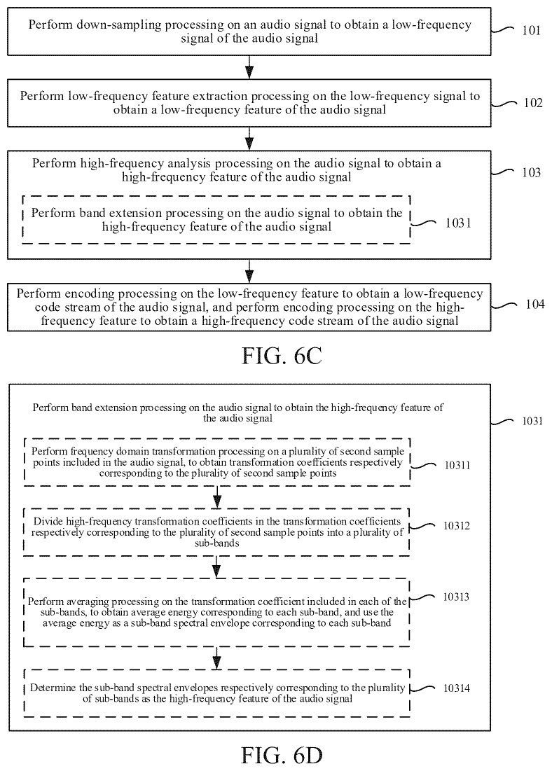

As described above, the audio encoding method provided in embodiments of this application may be implemented by various types of electronic devices, for example, a terminal, a server, or a combination thereof. Therefore, an execution subject of each operation is not described below. FIG. 6A is a first schematic flowchart of an audio encoding method according to an embodiment of this application. An audio encoding function is implemented through the audio encoding method. A description is provided below with reference to the operations shown in FIG. 6A.

Operation 101: Perform down-sampling processing on an audio signal to obtain a low-frequency signal of the audio signal.

In an example of obtaining an audio signal, in response to an audio collection instruction triggered by a transmitter (for example, an initiator of an online conference, an anchor, or an initiator of a voice call), an encoder side invokes a microphone built in a terminal device of the encoder side to collect an audio signal, to obtain an audio signal x(n) (which is also referred to as an input signal).

After the audio signal is obtained, down-sampling processing is performed on the audio signal, so as to extract a low-frequency signal from the audio signal. Because the low-frequency signal has more impact on audio encoding than a high-frequency signal, differential signal processing is subsequently performed on the low-frequency signal and the high-frequency signal.

The audio signal includes a low-frequency part and a high-frequency part. The low-frequency signal is the low-frequency part in the audio signal that is separated from the audio signal with a specific sampling rate through a filter based on a feature of the audio signal. The high-frequency signal is the high-frequency part in the audio signal that is separated from the audio signal with a specific sampling rate. For example, an effective bandwidth of an audio signal x(n) is 0-16 kHz, an effective bandwidth of a low-frequency signal is 0-8 kHz, and an effective bandwidth of a high-frequency signal x_{HB}(n) may be 6-16 kHz. In addition, frequency band division of the audio signal is not limited in this embodiment of this application. For example, the audio signal may be evenly or non-evenly divided, to obtain a uniform low-frequency signal and a uniform high-frequency signal.

The audio signal is a discrete digital signal. The audio signal includes a plurality of first sample points obtained through sampling. The first sample points are sampling values obtained through sampling from continuous analog signals.

In some embodiments, the audio signal includes a plurality of first sample points obtained through sampling. Operation 101 may be implemented in the following manner: performing down-sampling processing on each of the first sampling points included in the audio signal through a down-sampling filter, to obtain the low-frequency signal of the audio signal.

In the field of digital signal processing, a down-sampling filter is configured to reduce a sampling rate of the audio signal, to reduce data volume, reduce system complexity, or adapt to a specific application requirement. A down-sampling factor of the down-sampling filter may be a multiple of 2, for example, 2, 4, or 8.

The following processing is performed through the down-sampling filter: performing digital signal-based filtering processing on the first sampling point included in the audio signal, to obtain a filtered audio signal; and performing digital signal-based down-sampling processing on the filtered audio signal, to obtain the low-frequency signal of the audio signal. The digital signal-based filtering processing may be low-pass filtering, or may be band-pass filtering.

For example, in the field of digital signal processing, an audio signal is first filtered through the down-sampling filter, to remove a high-frequency component and aliasing interference in the audio signal, to ensure that the down-sampled audio signal does not lose necessary information. Then, a sampling point is reserved every certain sampling point in the filtered audio signal through the down-sampling filter, thereby reducing a sampling rate of the audio signal.

A description is provided by using an example in which the audio signal x(n) includes 640 sample points. The down-sampling filter is configured to extract a low-frequency signal x_{LB}(n) from the audio signal x(n). The down-sampling filter uses down-sampling filtering with a factor of ½, an effective bandwidth of the low-frequency signal is 0-8 kHz, and a number of sample points per frame is 320.

Operation 102: Perform low-frequency feature extraction processing on the low-frequency signal to obtain a low-frequency feature of the audio signal.

Because the low-frequency signal has more impact on audio encoding than the high-frequency signal, the low-frequency feature extraction processing may be performed on the low-frequency signal through a first NN model, to obtain the low-frequency feature, so that when completeness of the low-frequency feature is ensured, a feature dimension of the low-frequency feature is reduced as much as possible, thereby improving an audio encoding effect. The low-frequency feature is a feature representing the low-frequency signal, and the feature dimension of the low-frequency feature is lower than a feature dimension of the low-frequency signal.

The embodiments of this application are not limited to the model structure of the first NN. For example, the first NN may be a deep NN, a convolutional neural network (CNN), and the like.

FIG. 6B is a second schematic flowchart of an audio encoding method according to an embodiment of this application. FIG. 6B shows that operation 102 in FIG. 6A may be implemented through operation 1021 to operation 1024. Operation 1021: Perform convolution processing on the low-frequency signal to obtain a convolution feature of the low-frequency signal. Operation 1022: Perform pooling processing on the convolution feature to obtain a pooling feature of the low-frequency signal. Operation 1023: Perform down-sampling processing on the pooling feature to obtain a down-sampling feature of the low-frequency signal. Operation 1024: Perform convolution processing on the down-sampling feature to obtain the low-frequency feature of the audio signal.

In the field of audio encoding and decoding, operations such as convolution, pooling, and down-sampling of an NN play an important role, and are configured for processing an audio signal and extract a feature from the audio signal. During audio encoding and decoding, a convolution operation may be configured for extracting a local feature in the audio signal. By using a convolution kernel (a learnable filter), a convolution operation may be performed on a time dimension of the audio signal, to capture a mode and resonance in the signal. The convolution may extract time domain and frequency domain features in the audio signal, for tasks such as denoising, feature extraction, and signal separation. A pooling operation is configured for reducing the time dimension of the audio signal, thereby reducing data complexity and a calculation amount. In the pooling operation, a local region of an input signal may be sampled, and information of the region, such as a maximum value or an average value, is summarized, thereby generating a more compact feature representation. In the audio signal, the pooling operation may help improve robustness and a generalization capability of a network, and reduce a risk of overfitting. The down-sampling operation may be configured for reducing a sampling rate of the audio signal, i.e., reducing a frequency of a signal. The down-sampling operation helps reduce data volume, reduce storage and transmission overheads, and reduce complexity. The down-sampling may be performed in a frequency domain or a time domain, to reduce a sampling rate or reduce a dimension of a signal. In the field of audio encoding and decoding, operations such as convolution, pooling, and down-sampling may implement tasks such as feature extraction, encoding, and decoding of the audio signal by constructing an appropriate NN structure. These operations help improve audio signal processing efficiency and quality, and extend an application range of audio encoding and decoding technologies to fields such as audio processing, speech recognition, and music generation.

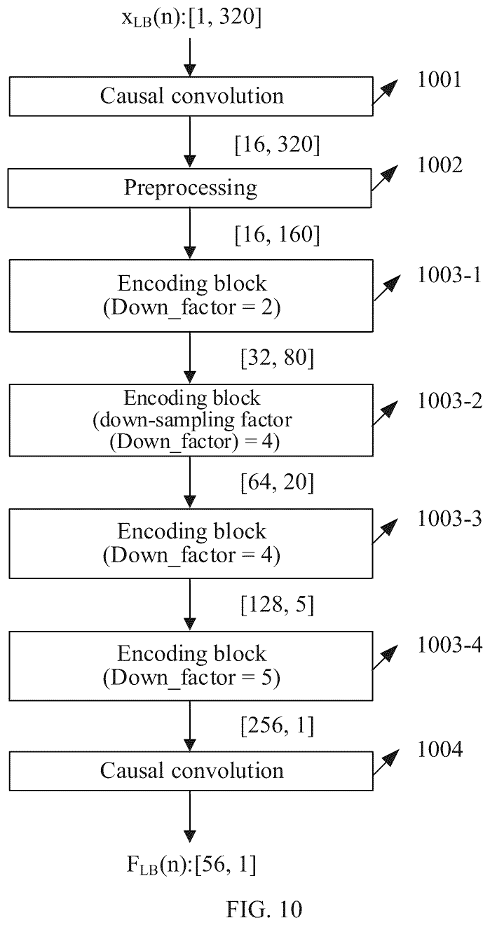

As shown in FIG. 10, based on a low-frequency signal x_{LB}(n), a first NN model is invoked to generate a lower-dimension eigenvector F_{LB}(n), i.e., a low-frequency feature. First, in operation 1021, convolution processing is performed on an inputted low-frequency signal x_{LB}(n) through a causal convolution 1001, to obtain a 16×320 convolution feature. Then, in operation 1022, pooling processing (i.e., preprocessing 1002) with a factor of 2 is performed on a 24×320 convolution feature, to obtain a 16×160 pooling feature. Next, in operation 1023, down-sampling processing is performed on a 24×160 pooling feature through an encoding block, to obtain a 256×1 down-sampling feature. Finally, in operation 1024, convolution processing is performed on the 256×1 down-sampling feature through a causal convolution 1004, to obtain a 56-dimension eigenvector F_{LB}(n).

The down-sampling processing in operation 1023 is implemented through a plurality of cascaded encoding layers. Therefore, operation 1023 may be implemented in the following manner: performing down-sampling processing on the pooling feature through a first encoding layer in the plurality of cascaded encoding layers; outputting a down-sampling result of the first encoding layer to a subsequent cascaded encoding layer, and further performing down-sampling processing and the outputting of the down-sampling result through the subsequent cascaded encoding layer until the down-sampling result is outputted to a last encoding layer; and determining a down-sampling result outputted by the last encoding layer as the down-sampling feature of the low-frequency signal.

As shown in FIG. 10, 4 encoding blocks (i.e., encoding layers) with different down-sampling factors (Down_factor) are cascaded to perform down-sampling processing on the pooling feature. In other words, down-sampling processing is performed on a 16×160 pooling feature through an encoding block 1003-1 of a down-sampling factor (Down_factor=2), to obtain a 32×80 down-sampling result first. Then, down-sampling processing is performed on the 32×80 down-sampling result through an encoding block 1003-2 of a down-sampling factor (Down_factor=4), to obtain a 64×20 down-sampling result. Next, down-sampling processing is performed on the 64×20 down-sampling result through an encoding block 1003-3 of the down-sampling factor (Down_factor=4), to obtain a 128×5 down-sampling result. Finally, down-sampling processing is performed on the 128×5 down-sampling result through the encoding block 1003-4 of a down-sampling factor (Down_factor=5), to obtain a 256×1 down-sampling feature. Using an encoding block (Down_factor=4) as an example, one or more dilated convolution may be first performed, and pooling is performed based on Down_factor, to implement a down-sampling function.

After processing by one encoding layer, understanding of the down-sampling feature is deepened. After learning by a plurality of encoding layers, the down-sampling feature of the low-frequency signal can be gradually and accurately learned. A down-sampling feature of a low-frequency signal with progressive precision can be obtained through the encoding layers in a cascaded form.

Operation 103: Perform high-frequency analysis processing on the audio signal to obtain a high-frequency feature of the audio signal.

A feature dimension of the high-frequency feature is lower than a feature dimension of the low-frequency feature. For example, the feature dimension of the low-frequency feature is 56, and the feature dimension of the high-frequency feature is 8. Because a low-frequency signal has more impact on audio encoding than a high-frequency signal, a low-frequency feature and a high-frequency feature of the audio signal are respectively extracted through differential signal processing, so that the feature dimension of the high-frequency feature is lower than the feature dimension of the low-frequency feature. The high-frequency analysis processing is configured for dimensionally reducing the high-frequency signal in the audio signal, to implement a function of data compression.

FIG. 6C is a third schematic flowchart of an audio encoding method according to an embodiment of this application. FIG. 6C shows that operation 103 in FIG. 6A may be implemented through operation 1031. Operation 1031: Perform band extension processing on the audio signal to obtain the high-frequency feature of the audio signal.

The high-frequency signal in the audio signal is rapidly compressed through operation 1031, to extract the high-frequency feature.

FIG. 6D is a fourth schematic flowchart of an audio encoding method according to an embodiment of this application. FIG. 6D shows that operation 1031 in FIG. 6C may be implemented through operation 10311 to operation 10314.

Operation 10311: Perform frequency domain transformation processing on a plurality of second sample points included in the audio signal, to obtain transformation coefficients respectively corresponding to the plurality of second sample points.

The frequency domain transformation method (i.e., a time-frequency transformation method) in operation 10311 may be a modified discrete cosine transform (MDCT), a discrete cosine transform (DCT), a fast Fourier transform (FFT), and the like. This embodiment of this application is not limited to a frequency domain transform mode.

In some embodiments, operation 10311 may be implemented in the following manner: obtaining a plurality of third sample points included in a reference audio signal, the reference audio signal being an audio signal adjacent to the audio signal; and performing, based on the plurality of third sample points included in the reference audio signal and the plurality of second sample points included in the audio signal, discrete cosine transformation processing on the plurality of second sample points included in the audio signal, to obtain transformation coefficients respectively corresponding to the plurality of second sample points.

In an example of operation 10311, for an audio signal x(n) including 640 second sample points, a modified MDCT method is invoked, to generate MDCT coefficients (i.e., transformation coefficients respectively corresponding to a plurality of second sample points) of the 640 second sample points. For example, if the MDCT method is 50% overlapping, an (n+1)^{th} frame of audio signal (i.e., the reference audio signal) and an n^{th} frame of audio signal (i.e., the audio signal) may be combined (spliced), an MDCT of 1280 sample points are calculated, and valid MDCT coefficients of the first 640 sample points are used as transformation coefficients respectively corresponding to the plurality of second sample points.

Operation 10312: Divide high-frequency transformation coefficients in the transformation coefficients respectively corresponding to the plurality of second sample points into a plurality of sub-bands.

Following the example of operation 10311, operation 10312 is specifically as follows. MDCT coefficients of the last 320 second sample points of the MDCT coefficients of the 640 second sample points (i.e., the transformation coefficients respectively corresponding to the plurality of second sample points) represent high-frequency signals, i.e., high-frequency transformation coefficients. The high-frequency transformation coefficient is divided into N sub-bands. The sub-bands herein are a group of a plurality of adjacent MDCT coefficients. The MDCT coefficients of the 320 second sample points may be divided into 8 sub-bands. For example, the MDCT coefficients of the 320 second sample points may be evenly allocated. In other words, each sub-band includes a same quantity of sample points. In this case, each sub-band includes MDCT coefficients of 40 second sample points. Certainly, non-uniform division on the 320 second sample points is not limited in this embodiment of this application. For example, a sub-band at a lower frequency includes fewer MDCT coefficients (a higher frequency resolution), and a sub-band at a higher frequency includes more MDCT coefficients (a lower frequency resolution).

According to the Nyquist sampling theorem (to recover an original signal from a sampled signal without distortion, a sampling frequency needs to be greater than 2 times a highest frequency of the original signal; when the sampling frequency is less than 2 times the highest frequency of a spectrum, the spectrum of the signal is aliased; and when the sampling frequency is greater than 2 times the highest frequency of the spectrum, the spectrum of the signal is not aliased), the MDCT coefficients of the foregoing 320 second sample points (points for short) represent a spectrum of 8-16 kHz. However, for ultra-wideband voice communication, the spectrum does not necessarily need to be set to 16 kHz. For example, if the spectrum is set to 14 kHz, only MDCT coefficients of the first 240 second sample points need to be considered. Correspondingly, a quantity of sub-bands may be controlled to be 6.

Operation 10313: Perform averaging processing on the transformation coefficient included in each of the sub-bands, to obtain average energy corresponding to each sub-band, and use the average energy as a sub-band spectral envelope corresponding to each sub-band.

The averaging processing in operation 10313 may be arithmetic averaging or geometric averaging. The averaging processing manner is not limited in this embodiment of this application.

The geometric averaging is used as an example. Operation 10313 may be implemented in the following manner: determining a quadratic sum of transformation coefficients corresponding to the second sample points included in each sub-band; and determining, as the average energy corresponding to each sub-band, a ratio of the quadratic sum to a quantity of second sample points included in the sub-band.

Following the example of 10312, operation 10313 is specifically as follows. For each sub-band, average energy of all MDCT coefficients in a current sub-band is calculated as a sub-band spectral envelope (the sub-band spectral envelope is a smooth curve passing through main peak points of the spectrum). For example, if the MDCT coefficients included in a current sub-band are x(n), n=1, 2, . . . , and 40, average energy corresponding to the current sub-band is Y=((x(1)²+x(2)²+ . . . +x(40)²)/40).

Operation 10314: Determine the sub-band spectral envelopes respectively corresponding to the plurality of sub-bands as the high-frequency feature of the audio signal.

Following the example of 10313, operation 10314 is specifically as follows. In a case in which the MDCT coefficients of 320 points are divided into 8 sub-bands, 8 sub-band spectral envelopes can be obtained. The 8 sub-band spectral envelopes are the high-frequency feature FHB (n) of the audio signal, i.e., a high-frequency eigenvector.

Operation 104: Perform encoding processing on the low-frequency feature to obtain a low-frequency code stream of the audio signal, and perform encoding processing on the high-frequency feature to obtain a high-frequency code stream of the audio signal.

In the field of digital signal processing, digital signal-based encoding processing is performed on the low-frequency feature, to obtain a low-frequency code stream of an audio signal, and digital signal-based encoding processing is performed on the high-frequency feature, to obtain a high-frequency code stream of an audio signal.

In some embodiments, operation 104 may be implemented in the following manner: performing quantization processing on the low-frequency feature to obtain an index value of the low-frequency feature; performing entropy encoding processing on the index value of the low-frequency feature to obtain the low-frequency code stream of the audio signal; performing quantization processing on the high-frequency feature to obtain an index value of the high-frequency feature; and performing entropy encoding processing on the index value of the high-frequency feature to obtain the high-frequency code stream of the audio signal.

In an example of operation 104, for the low-frequency feature F_{LB}(n) and the high-frequency feature F_{HB}(n), scalar quantization (where each component is separately quantized) and entropy coding methods may both be performed. In addition, a technical combination of VQ (combining a plurality of adjacent components into a vector to perform joint quantization) and entropy encoding are also not limited in this embodiment of this application. The high-frequency code stream and the low-frequency code stream obtained through encoding are combined and transmitted to a decoder side, and the high-frequency code stream and the low-frequency code stream are decoded through the decoder side.

Based on the above, according to the audio encoding method provided in the embodiments of this application, the audio signal is down-sampled to obtain a low-frequency signal. Because the low-frequency signal has more impact on audio encoding than a high-frequency signal in the audio signal, a low-frequency feature and a high-frequency feature of the audio signal are respectively extracted through differential signal processing, so that the feature dimension of the high-frequency feature is lower than the feature dimension of the low-frequency feature, and the low-frequency feature and the high-frequency feature whose feature dimensions are reduced are respectively encoded, thereby improving audio encoding efficiency while ensuring audio quality.

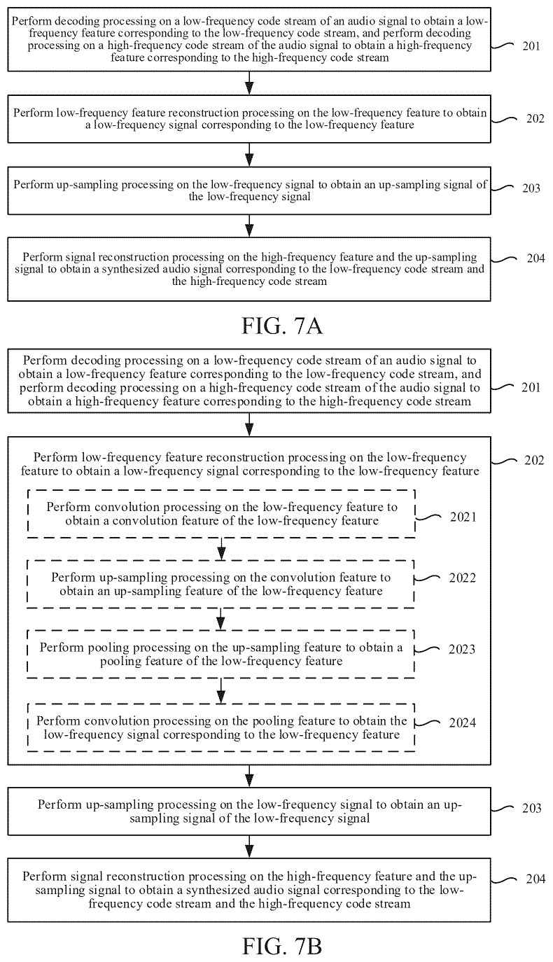

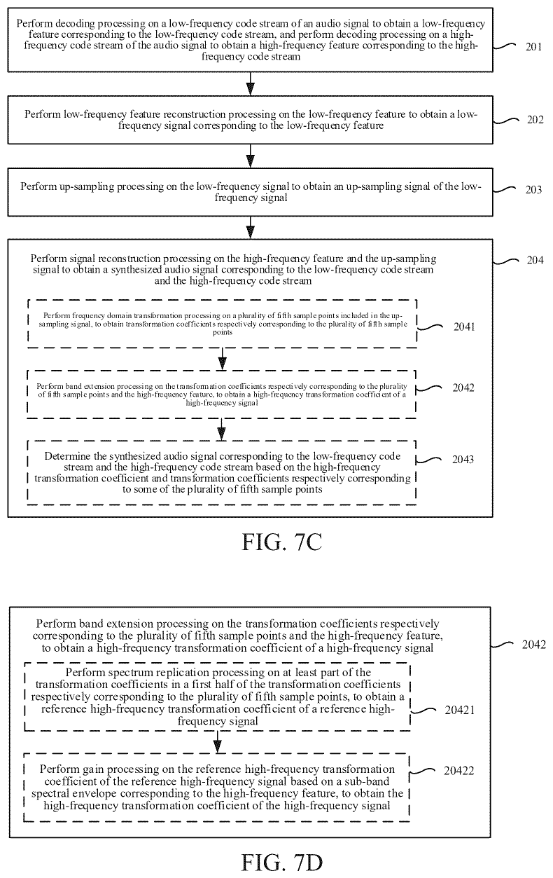

As described above, the audio decoding method provided in the embodiments of this application may be implemented by various types of electronic devices. FIG. 7A is a first schematic flowchart of an audio decoding method according to an embodiment of this application. An audio decoding function is implemented through the audio decoding method. A description is provided below with reference to operations shown in FIG. 7A.

Operation 201: Perform decoding processing on a low-frequency code stream of an audio signal to obtain a low-frequency feature corresponding to the low-frequency code stream, and perform decoding processing on a high-frequency code stream of the audio signal to obtain a high-frequency feature corresponding to the high-frequency code stream.

The low-frequency code stream is obtained by encoding a low-frequency signal obtained through down-sampling of the audio signal, and a feature dimension of the high-frequency feature is lower than a feature dimension of the low-frequency feature. For example, after the high-frequency code stream and the low-frequency code stream are obtained through encoding by using the audio encoding method shown in FIG. 6A, the high-frequency code stream and the low-frequency code stream obtained through encoding are combined and transmitted to a decoder side. After receiving the high-frequency code stream and the low-frequency code stream, the decoder side decodes the low-frequency code stream to obtain a low-frequency feature corresponding to the low-frequency code stream, and decodes the high-frequency code stream to obtain a high-frequency feature corresponding to the high-frequency code stream.

The decoding in operation 201 is a reverse process of encoding in operation 104. In the field of digital signal processing, digital signal-based decoding processing is performed on the low-frequency code stream of the audio signal, to obtain the low-frequency feature corresponding to the low-frequency code stream, and digital signal-based decoding processing is performed on the high-frequency code stream of the audio signal, to obtain the high-frequency feature corresponding to the high-frequency code stream.

In some embodiments, operation 201 may be implemented in the following manner: performing entropy decoding processing on the low-frequency code stream, to obtain an index value corresponding to the low-frequency code stream; performing inverse quantization processing on the index value corresponding to the low-frequency code stream, to obtain the low-frequency feature corresponding to the low-frequency code stream; performing entropy decoding processing on the high-frequency code stream, to obtain an index value corresponding to the high-frequency code stream; and performing inverse quantization on the index value corresponding to the high-frequency code stream, to obtain the high-frequency feature corresponding to the high-frequency code stream. The inverse quantization processing is implemented by querying a quantization table, and the quantization table is a mapping table generated through quantization in an encoding process.

In an example, entropy decoding is first performed on the received code streams (he high-frequency code stream and the low-frequency code stream), to obtain index values corresponding to the code streams. The quantization table is queried through the index values corresponding to the code streams. The queried eigenvectors are used as eigenvectors corresponding to the code streams. In other words, an estimated value F′_{LB}(n) of the low-frequency eigenvector (i.e., a low-frequency feature corresponding to the low-frequency code stream) and an estimated value F′_{HB}(n) of the high-frequency feature vector (i.e., a high-frequency feature corresponding to the high-frequency code stream) are obtained. A process in which the decoder side decodes the received code stream is a reverse process of a process in which the encoder side performs encoding. Therefore, a value generated in the decoding process is an estimated value relative to a value in the encoding process. For example, a high-frequency feature generated in the decoding process is an estimated value relative to a high-frequency feature in the encoding process.

Operation 202: Perform low-frequency feature reconstruction processing on the low-frequency feature to obtain a low-frequency signal corresponding to the low-frequency feature.

For example, the low-frequency feature reconstruction in operation 202 is an inverse process of the low-frequency feature extraction in operation 102. The low-frequency feature reconstruction processing is performed on the low-frequency feature through a second NN model, to obtain the low-frequency signal (an estimated value corresponding to the low-frequency signal obtained in the encoding process) corresponding to the low-frequency feature.

The embodiments of this application are not limited to the model structure of the second NN. For example, the second NN may be a deep NN, a CNN, and the like.

FIG. 7B is a second schematic flowchart of an audio decoding method according to an embodiment of this application. FIG. 7B shows that operation 202 in FIG. 7A may be implemented through operation 2021 to operation 2024. Operation 2021: Perform convolution processing on the low-frequency feature to obtain a convolution feature of the low-frequency feature. Operation 2022: Perform up-sampling processing on the convolution feature to obtain an up-sampling feature of the low-frequency feature. Operation 2023: Perform pooling processing on the up-sampling feature to obtain a pooling feature of the low-frequency feature. Operation 2024: Perform convolution processing on the pooling feature to obtain the low-frequency signal corresponding to the low-frequency feature.

In the field of audio encoding and decoding, an up-sampling operation is configured for increasing resolution of a feature map, to reconstruct an audio signal more accurately. Up-sampling relates to interpolation or another form of up-sampling technology, to generate a feature map with higher precision, which helps better recover original details and features of an audio signal in a decoding process. By using NN technologies such as convolution, pooling, and up-sampling in audio decoding, useful features can be effectively extracted, calculation complexity can be reduced, and original content of the audio signal can be reconstructed more accurately. These technologies have significant significance for improving audio decoding performance and efficiency, and help promote the development and application of audio encoding and decoding technologies.

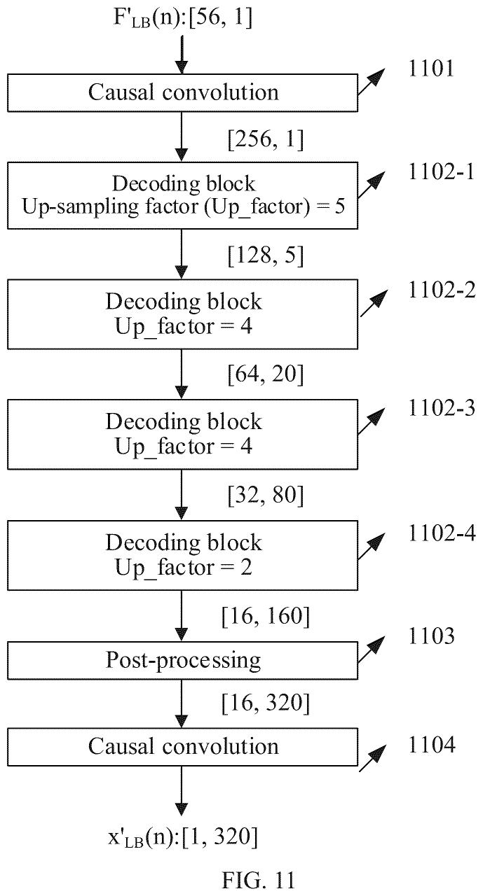

As shown in FIG. 11, based on a low-frequency feature F′_{LB}(n), an NN model shown in FIG. 11 is invoked, to generate a low-frequency signal x′_{LB}(n). The NN model shown in FIG. 11 is similar to the NN model shown in FIG. 10. For example, a causal convolution and a post-processing structure are similar to preprocessing. A structure of the decoding block is symmetrical to that of the encoding block on the encoder side. The encoding block on the encoder side first performs dilated convolution, and then performs pooling to complete down-sampling, while the decoding block on the decoder side first performs pooling to complete up-sampling and then performs dilated convolution.

First, in operation 2021, convolution processing is performed on an input low-frequency feature F′_{LB}(n) through a causal convolution 1101, to obtain a 256×1 convolution feature. Then, in operation 2022, up-sampling processing is performed on the 256×1 convolution feature, to obtain a 16×160 up-sampling feature. Next, in operation 2023, pooling processing (i.e., post-processing 1103) is performed on the 16×160 up-sampling feature, to obtain a 16×320 pooling feature. Finally, in operation 2024, convolution processing is performed on the 16×320 pooling feature through a causal convolution 1104, to obtain a 320-dimension low-frequency signal x′_{LB}(n).

The up-sampling processing in operation 2022 is implemented through a plurality of cascaded decoding layers. Therefore, operation 2022 may be implemented in the following manner: performing up-sampling processing on the convolution feature through a first decoding layer in the plurality of cascaded decoding layers; outputting an up-sampling result of the first decoding layer to a subsequent cascaded decoding layer, and further performing up-sampling processing and the outputting of the up-sampling result through the subsequent cascaded decoding layer until the up-sampling result is outputted to a last decoding layer; and determining an up-sampling result outputted by the last decoding layer as the up-sampling feature of the low-frequency feature.

In an example of operation 2022, as shown in FIG. 11, 4 decoding blocks (i.e., decoding layers) with different up-sampling factors (Up_factor) are cascaded to perform up-sampling processing on the convolution feature. First, up-sampling processing is performed on a 256×1 convolution feature through the decoding block 1102-1 of an up-sampling factor (Up_factor=5), to obtain a 128×5 up-sampling result, then up-sampling processing is performed on the 128×5 up-sampling result through a decoding block 1102-2 of an up-sampling factor (Up_factor=4), to obtain a 64×20 up-sampling result, then up-sampling processing is performed on the 64×20 up-sampling result through a decoding block 1102-3 of the up-sampling factor (Up_factor=4), to obtain a 32×80 up-sampling result, and finally up-sampling processing is performed on the 32×80 up-sampling result through the decoding block 1102-4 of the up-sampling factor (Up_factor=2), to obtain a 16×160 up-sampling feature. Using a decoding block (Up_factor=4) as an example, pooling may be performed based on the Up_factor first, and then one or more dilated convolutions are performed, to implement an up-sampling function.

After processing by one decoding layer, understanding of the up-sampling feature is deepened. After learning by a plurality of decoding layers, the up-sampling feature of the low-frequency feature can be gradually and accurately learned. An up-sampling feature of a low-frequency feature with progressive precision can be obtained through decoding layers in a cascaded form.

Operation 203: Perform up-sampling processing on the low-frequency signal to obtain an up-sampling signal of the low-frequency signal.

For example, an example in which a sampling rate of an encoder side is ½ is used. A sampling rate of a low-frequency signal x′_{LB}(n) obtained on a decoder side is only ½ of a sampling rate of an audio signal x(n) on the encoder side. Therefore, up-sampling needs to be performed on the low-frequency signal x′_{LB}(n) and the sampling rate is expanded by 1 times, to generate an up-sampling signal xᵤₚ(n). Therefore, it is ensured that a sampling rate of the up-sampling signal is the same as a sampling rate of the audio signal.

In some embodiments, operation 203 may be implemented in the following manner: performing up-sampling processing on a fourth sampling point included in the low-frequency signal through an up-sampling filter, to obtain the up-sampling signal of the low-frequency signal.

In the field of digital signal processing, an up-sampling filter is configured to increase a sampling rate of a signal inputted into the up-sampling filter, so as to better capture detailed information in the signal or extend a spectrum range. An up-sampling factor of the up-sampling filter may be a multiple of 2, for example, 2, 4, or 8.

The following processing is performed through the up-sampling filter: performing digital signal-based up-sampling processing on the fourth sampling point included in the low-frequency signal, to obtain an up-sampled low-frequency signal; and performing digital signal-based filtering processing on the up-sampled low-frequency signal to obtain an up-sampling signal of the low-frequency signal. The digital signal-based filtering processing may be low-pass filtering, or may be band-pass filtering.

For example, in the field of digital signal processing, digital signal-based up-sampling processing is first performed on a fourth sampling point included in the low-frequency signal through an up-sampling filter. The up-sampling means to increase a sampling rate by inserting a zero value into the low-frequency signal. The digital signal-based filtering processing is performed on the up-sampled low-frequency signal, to remove aliasing interference introduced by interpolation.

A description is made by using an example in which 320 sample points are included in the low-frequency signal x′_{LB}(n). The up-sampling filter is configured to double a sampling rate of the low-frequency signal x′_{LB}(n). The up-sampling filter uses up-sampling filtering with a factor of 2, to expand the sampling rate of the low-frequency signal x′_{LB}(n) by 1 times, to generate an up-sampling signal xᵤₚ(n), where each frame xᵤₚ(n) includes 640 sample points (referred to as points for short).

Operation 204: Perform signal reconstruction processing on the high-frequency feature and the up-sampling signal to obtain a synthesized audio signal corresponding to the low-frequency code stream and the high-frequency code stream.

For signal reconstruction, the high-frequency signal is obtained through band extension based on the high-frequency feature and the up-sampling signal, and a combined audio signal is obtained through combination based on the up-sampling signal and the reconstructed high-frequency signal x′(n).

FIG. 7C is a third schematic flowchart of an audio decoding method according to an embodiment of this application. FIG. 7C shows that operation 204 in FIG. 7A may be implemented through operation 2041 to operation 2043.

Operation 2041: Perform frequency domain transformation processing on a plurality of fifth sample points included in the up-sampling signal, to obtain transformation coefficients respectively corresponding to the plurality of fifth sample points.

The frequency domain transformation method (i.e., a time-frequency transformation method) in operation 2041 may be a MDCT, a DCT, an FFT, and the like. This embodiment of this application is not limited to a frequency domain transform mode.

In some embodiments, operation 2041 may be implemented in the following manner: obtaining a plurality of sample points included in a reference up-sampling signal, the reference up-sampling signal being an up-sampling signal adjacent to the up-sampling signal; and performing discrete cosine transformation processing on the plurality of fifth sample points included in the up-sampling signal based on the plurality of sample points included in the reference up-sampling signal and the plurality of fifth sample points included in the up-sampling signal, to obtain transformation coefficients respectively corresponding to the plurality of fifth sample points.

In an example of operation 2041, for an up-sampling signal xᵤₚ(n) including 640 sample points, an MDCT method is invoked, to generate MDCT coefficients (i.e., transformation coefficients respectively corresponding to a plurality of fifth sample points) of the 640 sample points. Specifically, If the MDCT method is 50% overlapping, an (n+1)^{th} frame of up-sampling signal (i.e., the reference up-sampling signal) and an n^{th} frame of up-sampling signal (i.e., the up-sampling signal) may be combined (spliced), and an MDCT of 1280 sample points (including the plurality of sample points included in the reference up-sampling signal and the plurality of fifth sample points included in the up-sampling signal) are calculated. Because the calculated MDCT of the 1280 sample points are of an up-sampling signal form, and high-frequency content is missing, content of a low-frequency part of the calculated MDCT of the 1280 sample points is reserved. In other words, valid MDCT coefficients of the first 640 sample points are used as transformation coefficients Xᵤₚ(n) respectively corresponding to the plurality of fifth sample points.

Operation 2042: Perform band extension processing on the transformation coefficients respectively corresponding to the plurality of fifth sample points and the high-frequency feature, to obtain a high-frequency transformation coefficient of a high-frequency signal.

Through a band extension technology, the high-frequency transformation coefficient of the high-frequency signal is reconstructed based on the transformation coefficients respectively corresponding to the plurality of fifth sample points and the high-frequency feature.

FIG. 7D is a fourth schematic flowchart of an audio decoding method according to an embodiment of this application. FIG. 7D shows that operation 2042 in FIG. 7C may be implemented through the following operation 20421 to operation 20422.

Operation 20421: Perform spectrum replication processing on at least part of the transformation coefficients in a first half of the transformation coefficients respectively corresponding to the plurality of fifth sample points, to obtain a reference high-frequency transformation coefficient of a reference high-frequency signal.

In some embodiments, operation 20421 may be implemented in the following manner: performing spectrum replication processing on a second half of the transformation coefficients of the first half of the transformation coefficients respectively corresponding to the plurality of fifth sample points, to obtain the reference high-frequency transformation coefficient of the reference high-frequency signal.

In an example of operation 20421, the transformation coefficients respectively corresponding to the plurality of fifth sample points are Xᵤₚ(n) (including MDCT coefficients of 640 points). Low-frequency MDCT coefficients in Xᵤₚ(n) (i.e., MDCT coefficients of first 320 points) are replicated, to generate reference values of the MDCT coefficients of the high-frequency part, i.e., reference high-frequency transformation coefficients of reference high-frequency signals. With reference to basic features of a voice signal, more harmonics exist in a low-frequency part, and fewer harmonics exist in a high-frequency part. Therefore, to avoid excessive harmonics in the generated high-frequency MDCT spectrum caused by simple replication, last 160 points (i.e., second half transformation coefficients of the first half in the transformation coefficients respectively corresponding to the plurality of fifth sample points) of the low-frequency MDCT coefficients in Xᵤₚ(n) are used as a master, and are replicated 2 times in the high-frequency part of the spectrum, to generate reference values of the MDCT coefficients of 320 points of the high-frequency part signal (i.e., the reference high-frequency transformation coefficients of the reference high-frequency signal). Therefore, after the spectrum replication, the last 320 points in xᵤₚ(n) are non-zero coefficients.

Certainly, in this embodiment of this application, the last 160 points of low-frequency MDCT coefficients in Xᵤₚ(n) are not limited to be used as the master. Low-frequency MDCT coefficients in Xᵤₚ(n) may also be used as the master, spectrum replication is performed 1 times, and the reference values of the MDCT coefficients of 320 points of the high-frequency part signal are generated. Last 80 points of the low-frequency MDCT coefficients in Xᵤₚ(n) may also be used as the master, spectrum replication is performed 4 times, and the reference values of the MDCT coefficients of 320 points of the high-frequency part signal are generated.

Operation 20422: Perform gain processing on the reference high-frequency transformation coefficient of the reference high-frequency signal based on a sub-band spectral envelope corresponding to the high-frequency feature, to obtain the high-frequency transformation coefficient of the high-frequency signal.

In some embodiments, operation 20422 may be implemented in the following manner: dividing the reference high-frequency transformation coefficient of the reference high-frequency signal into a plurality of sub-bands based on the sub-band spectral envelope corresponding to the high-frequency feature; and performing the following processing for any one of the plurality of sub-bands: determining first average energy of a high-frequency sub-band corresponding to the sub-band in the sub-band spectral envelope, and determining second average energy of the sub-band; determining a gain factor based on a ratio of the first average energy to the second average energy; multiplying the gain factor by each reference high-frequency transformation coefficient included in the sub-band, to obtain a high-frequency transformation coefficient corresponding to the sub-band; and determining the high-frequency transformation coefficient corresponding to each of the plurality of sub-bands as the high-frequency transformation coefficients of the high-frequency signal.

Following the example of 20421, operation 20422 is specifically as follows. Sub-band spectral envelopes (for example, 8 sub-band spectral envelopes) corresponding to the high-frequency features are estimated values F′_{HB}(n) corresponding to the high-frequency features obtained after decoding. The 8 sub-band spectral envelopes correspond to 8 high-frequency sub-bands, and the reference values of the MDCT coefficients of 320 points of the generated high-frequency part signal (i.e., the reference high-frequency transformation coefficients of the reference high-frequency signal) are divided into 8 sub-bands. Based on a high-frequency sub-band and a corresponding sub-band, gain (multiplication is performed in a frequency domain) is performed on the reference values of the MDCT coefficients of 320 points of the high-frequency part signal. For example, a gain factor is calculated based on average energy of the high-frequency sub-band and the average energy of a corresponding sub-band, and an MDCT coefficient corresponding to each point in the corresponding sub-band is multiplied by the gain factor, to ensure that energy of the high-frequency MDCT coefficient generated through decoding is close to original coefficient energy of the encoder side.

For example, it is assumed that average energy of the sub-band (i.e., the sub-band obtained by dividing the reference values of the MDCT coefficients of 320 points of the generated high-frequency part signal) is Y_L, and average energy of a current high-frequency sub-band (i.e., a sub-band corresponding to a sub-band spectral envelope obtained by decoding based on a code stream) is Y_H, a gain factor a=sqrt (Y_H/Y_L) is calculated. After the gain factor a is provided, an MDCT coefficient of each point in a sub-band is directly multiplied by a. Average energy of the MDCT coefficients (i.e., the high-frequency transformation coefficients of the high-frequency signal) on which the gain control is performed is excessively close to original average energy at the encoder side, to restore the original high-frequency signal as much as possible.

Operation 2043: Determine the synthesized audio signal corresponding to the low-frequency code stream and the high-frequency code stream based on the high-frequency transformation coefficient and transformation coefficients respectively corresponding to some of the plurality of fifth sample points.

In some embodiments, operation 2043 may be implemented in the following manner: performing combining processing on the high-frequency transformation coefficient and transformation coefficients respectively corresponding to a first half of fifth sample points in the plurality of fifth sample points, to obtain a complete transformation coefficient; and performing inverse transformation processing of spectrum transformation on the complete transformation coefficient, to obtain the synthesized audio signal corresponding to the low-frequency code stream and the high-frequency code stream.

Following the example of 20422, operation 2043 is specifically as follows. The low-frequency MDCT coefficients (i.e., the MDCT coefficients of the first 320 points, to be specific, transformation coefficients respectively corresponding to some fifth sample points of the plurality of fifth sample points) in Xᵤₚ(n) and the MDCT coefficients obtained after the gain control (i.e., reference values of MDCT coefficients of the last 320 points after gain in Xᵤₚ(n), to be specific, high-frequency transformation coefficients) are combined, to obtain complete transformation coefficients (i.e., MDCT coefficients of 640 points, including low-frequency MDCT coefficients and high-frequency MDCT coefficients). Inverse MDCT transformation (i.e., inverse transformation processing of spectrum transformation) is performed on the complete transformation coefficients, to generate reference values of MDCT of 1280 points. Through overlapping, valid reference values of MDCT of first 640 points are used as the synthesized audio signal.

Based on the above, according to the audio decoding method provided in the embodiments of this application, the received code streams (i.e., the low-frequency code stream and the high-frequency code stream) are decoded, to obtain the low-frequency feature and the high-frequency feature, and the inverse process of a corresponding encoder side is invoked for the low-frequency eigenvector, to complete reconstruction of the low-frequency part. Then, the reconstructed low-frequency part (i.e., the low-frequency signal) is restored to a sampling rate the same as that of the original inputted audio signal through up-sampling filtering. The high-frequency transformation coefficient of the high-frequency signal is reconstructed by combining the low-frequency part and the high-frequency feature obtained after up-sampling filtering, and the reconstructed low-frequency part and high-frequency transformation coefficient are combined, to ensure that energy of the reconstructed high-frequency signal is close to energy of the high-frequency signal of the encoder side. In this way, complete reconstruction of frequency domain coefficients from the low frequency to the high frequency is obtained.

Next, an exemplary application of the embodiments of this application in an actual application scene is to be described.

The embodiments of this application may be applied to various audio scene, such as a voice call and instant messaging. A description is provided below by using the voice call as an example.

In the related art, principles of voice encoding are substantially as follows. The voice encoding may directly encode voice waveform samples one by one. Alternatively, related low-dimensional features are extracted based on a human vocalizing principle, the features are encoded on an encoder side, and a voice signal is reconstructed on a decoder side based on the parameters.

The foregoing encoding principles come from voice signal modeling, i.e., a signal processing-based compression method. To improve encoding efficiency while ensuring voice quality compared to the signal processing-based compression method, an embodiment of this application provides a low-rate NN encoding and decoding method (i.e., an audio processing method). Down-sampling filtering is performed on a voice signal with a specific sampling rate based on a voice signal feature, to separate a most important low-frequency part (i.e., the low-frequency signal). After the important low-frequency part (i.e., the low-frequency signal) is processed based on an NN technology, an eigenvector having a dimension lower than that of an inputted low-frequency signal is obtained. For a relatively unimportant part (a high-frequency part, i.e., a high-frequency signal) in a voice signal, fewer bits are configured for encoding. The low-frequency part and the high-frequency part of the voice signal are separately processed for the encoder side, to obtain eigenvectors (a low-frequency eigenvector and a high-frequency eigenvector) having a dimension lower than that of the inputted voice signal, and the eigenvectors are compressed and encoded. The received code streams (i.e., the low-frequency code stream and the high-frequency code stream) are decoded for the decoder side, to obtain the low-frequency eigenvector and the high-frequency eigenvector, and the inverse process of a corresponding encoder side is invoked for the low-frequency eigenvector, to complete reconstruction of the low-frequency part. Then, the reconstructed low-frequency part is restored to a sampling rate the same as that of the original inputted voice signal through up-sampling filtering. A high-frequency part is reconstructed by combining the low-frequency part and the high-frequency eigenvector that are obtained after the up-sampling filtering, and the reconstructed low-frequency part and high-frequency part are combined, to complete decoding.

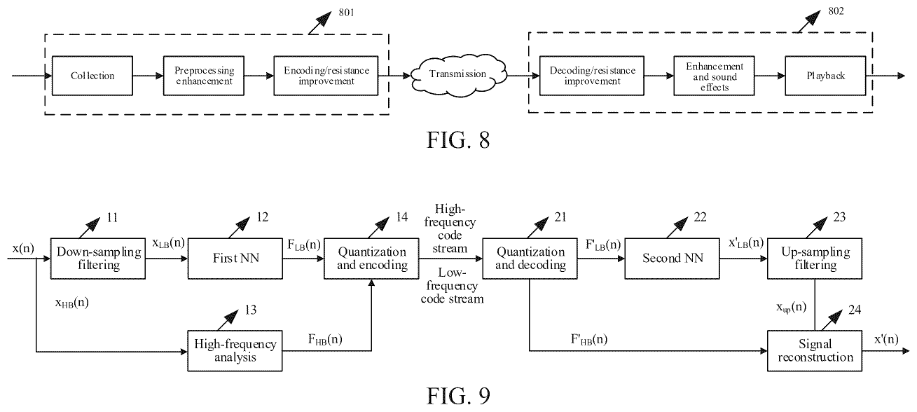

The embodiments of this application may be applied to a voice communication link shown in FIG. 8. Using a voice over Internet protocol (VOIP) conference system as an example, the voice encoding and decoding technology involved in the embodiments of this application is deployed in encoding and decoding parts, to resolve a basic function of voice compression. The encoder is deployed in an uplink client 801. A decoder is deployed in a downlink client 802. A voice is collected through the uplink client, and processing such as preprocessing enhancement and encoding is performed, a code stream obtained through the encoding is transmitted to the downlink client 802 through a network, and processing such as decoding and enhancement is performed through the downlink client 802, so that the decoded voice is played back in the downlink client 802.

Considering forward compatibility (i.e., a new encoder is compatible with an existing encoder), a transcoder needs to be deployed in a background (i.e., a server) of a system, to resolve a problem of interconnecting between the new encoder and the existing encoder. For example, if a transmission end (an uplink client) is a new NN encoder, a receiving end (a downlink client) is a public switched telephone network (PSTN) (G.722). In the background, an NN decoder needs to be executed to generate a voice signal, and then a G.722 encoder is invoked to generate a specific code stream, to implement a transcoding function, so that the receiving end may perform correct decoding based on the specific code stream.

The low-rate NN encoding and decoding method (implemented by the audio encoding method and the audio decoding method) provided in this embodiment of this application is described below with reference to FIG. 9.

The following processing is performed for the encoder side.

For an n^{th} frame of an input voice signal x(n), a low-frequency part signal x_{LB}(n) of the voice signal x(n) is extracted through a down-sampling filter, which is referred to as a low-frequency signal for short.

For a low-frequency part signal x_{LB}(n), a first NN is invoked, to obtain a low-dimension eigenvector F_{LB}(n) (referred to as a low-frequency feature for short). A dimension of the eigenvector F_{LB}(n) is less than a dimension of a low-frequency sub-band signal, to reduce data volume. For example, for each frame X_{LB}(n), a dilated CNN is invoked, to generate a lower-dimension eigenvector F_{LB}(n). Another NN structure is not limited in the embodiments of this application, such as an autoencoder, a full-connection (FC) network, a long short-term memory (LSTM) network, a CNN+LSTM.

In addition, a high-frequency analysis is performed on the voice signal x(n), to extract the high-frequency eigenvector FHB (n) (referred to as the high-frequency feature for short). Considering that the high frequency is less important to quality importance than the low frequency, in this embodiment of this application, the high-frequency signal may be generated through only 1-2 kbps based on a band extension technology for a voice signal analysis. An implementation of the high-frequency analysis based on band extension includes: performing time-frequency transformation on the voice signal x(n), to obtain a frequency domain coefficient; combining adjacent coefficients of the frequency domain coefficients into a plurality of sub-bands; calculating average energy of each sub-band as a spectrum envelope of the sub-band, an operation being performed on only the frequency domain coefficient related to the high frequency; and extracting the extracted spectrum envelope related to a high frequency as F_{HB}(n).

For eigenvectors (i.e., F_{LB}(n) and F_{HB}(n)) corresponding to the sub-band, VQ or scalar quantization is performed, entropy encoding is performed on a quantized index value, and a code stream obtained after encoding is transmitted to the decoder side.

The following processing is performed for the decoder side.

A code stream received by the decoder side is decoded, to separately obtain an estimated value F_{LB}(n) of a low-frequency eigenvector (referred to as a low-frequency feature for short) and an estimated value F_{HB}(n) of a high-frequency eigenvector (referred to as a high-frequency feature for short).

For a low-frequency part, a second NN is invoked based on the estimated value F_{LB}(n) of the low-frequency eigenvector, to generate an estimated value x_{LB}(n) of a low-frequency signal.

Up-sampling filtering is performed on the generated estimated value x_{LB}(n) of the low-frequency signal, to generate xᵤₚ(n), a sampling rate of xᵤₚ(n) being consistent with a sampling rate of the voice signal x(n) inputted by the encoder side.

For the signal reconstruction, the signal reconstruction mainly includes reconstruction of a high-frequency part based on band extension, and combination of a low-frequency signal and the reconstructed high-frequency signal to obtain a final output signal x′(n). First, time-frequency transformation is performed on xᵤₚ(n), to obtain a frequency domain coefficient. As described above, the resolution of the frequency domain coefficient is the same as a resolution of the inputted voice signal x(n). Second, because a high-frequency component is missing from a frequency domain coefficient, a high-frequency component (i.e., a frequency domain coefficient of a high-frequency part) is generated based on the band extension technology, and the high-frequency component and the frequency domain coefficient of a low-frequency part are combined to generate a complete frequency domain coefficient. Third, an inverse time-frequency transformation is performed on the complete frequency domain coefficient, to obtain a final output signal x′(n). The band extension technology includes: replicating the frequency domain coefficient of the low-frequency part to the high-frequency part; and performing, based on the obtained high-frequency eigenvector F_{HB}(n), energy adjustment on the frequency domain coefficient of the high-frequency part according to a sub-band, to ensure that reconstructed energy of the high-frequency part is close to high-frequency energy of the encoder side. In this way, complete reconstruction of frequency domain coefficients from the low frequency to the high frequency is obtained.

The low rate NN encoding method provided in the embodiments of this application is described in detail below.

In some embodiments, a voice signal with a sampling rate Fs=32000 Hz is used as an example (the method provided in the embodiments of this application is also applicable to another sampling rate scene, including but not limited to 8000 Hz, 16000 Hz, and 48000 Hz). In addition, it is assumed that a length of a frame is set to 20 ms. Therefore, for Fs=32000 Hz, it is equivalent to that each frame includes 640 sample points.

The encoder side and the decoder side are described in detail with reference to the flowchart shown in FIG. 9.

The process of the encoder side is as follows.

For a voice signal with a sampling rate Fs=32000 Hz, an n^{th} frame of input signal includes 640 sample points (referred to as points for short), which are recorded as an input signal x(n).

Operation 11: Perform down-sampling filtering.

The down-sampling filtering in this embodiment of this application is to separate a low-frequency signal x_{LB}(n) from an original input signal x(n). In this embodiment of this application, down-sampling filtering with a factor of ½ is used. Therefore, an effective bandwidth of the low-frequency signal is 0-8 kHz, and a number of sample points per frame is 320.

Operation 12: Input the low-frequency signal x_{LB}(n) into a first NN to perform data compression.

Based on the low-frequency signal x_{LB}(n), the first NN is invoked to generate a lower-dimension eigenvector F_{LB}(n). A dimension of x_{LB}(n) is 320, and a dimension of F_{LB}(n) is 56. From a perspective of data volume, the first NN performs a function of “dimension reduction”, to implement a function of data compression.

Reference is made to a network structure diagram of the first NN shown in FIG. 10, a process in which data compression is performed through the first NN is specifically described below.

First, a 16-channel causal convolution 1001 is invoked, and an inputted tensor (i.e., the low-frequency signal x_{LB}(n)) may be extended into a 16×320 tensor.

Then, preprocessing 1002 is performed on the 16×320 tensor. For example, a pooling operation with a factor of 2 is performed on the 16×320 tensor, and an activation function may be ReLU, to generate a 16×160 tensor.

Next, 4 encoding blocks (i.e., an encoding block 1003-1, an encoding block 1003-2, an encoding block 1003-3, and an encoding block 1003-4) with different down-sampling factors (Down_factor) are cascaded. Using an encoding block (Down_factor=2) as an example, one or more void convolution may be first performed, a size of each convolution kernel is fixed to 1×3, and a stride rate is 1. In addition, a dilation rate of one or more dilated convolution may be set based on an actual requirement, for example, 3. Certainly, the expansion rate of different dilated convolution settings is not limited in this embodiment of this application either. Then, Down_factor of the 4 encoding blocks is respectively set to 2, 4, 4, and 5, which are equivalent to pooling factors with different values and have a down-sampling function. Finally, the number of channels of the 4 encoding blocks are respectively set to 32, 64, 128, and 256. Therefore, through the 4 encoding blocks, the 16×160 tensor is sequentially converted into tensors of 32×80, 64×20, 128×5, and 256×1. Another implementation of the encoding block is not limited in this embodiment of this application, such as the number of dilated convolution (including the expansion rate), a value of a down-sampling factor in each encoding block, and the number of output channels of each encoding block. Provided that the foregoing configuration is ensured, and a dimension in which an input of the first NN is 1×320 and an output of the first NN is 56×1 is matched.

Finally, causal convolution 1004 similar to the preprocessing is performed on the 256×1 tensor, and a 56-dimension eigenvector F_{LB}(n) may be outputted.

Operation 13: Perform a high-frequency analysis on the input signal x(n).

An objective of the high-frequency analysis is to analyze the input signal x(n), extract key information related to the high-frequency signal, and generate the lower-dimension eigenvector F_{HB}(n).

This embodiment of this application provides performing the high-frequency analysis on the input signal based on band extension (recovering a wideband voice signal from a band-limited narrowband voice signal). The Application of the band extension in the embodiments of this application is specifically described below.

For an input signal x(n) including 640 points, an MDCT is invoked, to generate MDCT coefficients of 640 points. For example, if the MDCT method is 50% overlapping, an (n+1)^{th} frame of input signal data and an n^{th} frame of the input signal may be combined (spliced), the MDCT of 1280 points are calculated, and the MDCT coefficients of 640 points are obtained.

For the high-frequency analysis, in this embodiment of this application, MDCT coefficients of the last 320 points of the MDCT coefficients of the 640 points represent a high-frequency signal. The MDCT coefficients of 320 points (i.e., the high-frequency signal) are divided into N sub-bands. The sub-bands are groups of a plurality of adjacent MDCT coefficients. The MDCT coefficients of 320 points may be divided into 8 sub-bands. For example, the 320 points may be evenly allocated. In other words, each sub-band includes the same quantity of points. Certainly, a non-uniform division of the 320 points is not limited in this embodiment of this application. For example, a sub-band at a lower frequency includes fewer MDCT coefficients (a higher frequency resolution), and a sub-band at a higher frequency includes more MDCT coefficients (a lower frequency resolution).

According to the Nyquist sampling theorem (to recover an original signal from a sampled signal without distortion, a sampling frequency needs to be greater than 2 times a highest frequency of the original signal; when the sampling frequency is less than 2 times the highest frequency of a spectrum, the spectrum of the signal is aliased; and when the sampling frequency is greater than 2 times the highest frequency of the spectrum, the spectrum of the signal is not aliased), the MDCT coefficients of the foregoing 320 points represent a spectrum from 8-16 kHz. However, for ultra-wideband voice communication, the spectrum does not necessarily need to be set to 16 kHz. For example, if the spectrum is set to 14 kHz, only MDCT coefficients of the first 240 points need to be considered. Correspondingly, the quantity of sub-bands may be controlled to be 6.

For each sub-band, average energy of all MDCT coefficients in a current sub-band is calculated as a sub-band spectral envelope (the sub-band spectral envelope is a smooth curve passing through main peak points of a spectrum). For example, if the MDCT coefficients included in a current sub-band are x(n), n=1, 2, . . . , and 40, average energy is Y=((x(1)²+x(2)²+ . . . +x(40)²)/40). In a case in which the MDCT coefficients of 320 points are divided into 8 sub-bands, 8 sub-band spectral envelopes can be obtained. The 8 sub-band spectral envelopes are the eigenvector F_{HB}(n) of the generated high-frequency signal.

Based on the above, in the high-frequency analysis part, an 8-dimension eigenvector is outputted, to represent a key feature of the high-frequency part of the input signal. Therefore, only a small amount of data is needed to represent high-frequency information, and encoding efficiency is significantly improved.

Operation 14: Perform quantization and encoding.

For the eigenvector F_{LB}(n) of the low-frequency signal and the eigenvector F_{HB}(n) of the high-frequency signal, a scalar quantization (where each component is separately quantized) method and an entropy coding method may be performed. In addition, a technical combination of VQ (combining a plurality of adjacent components into a vector to perform joint quantization) and entropy encoding are also not limited in this embodiment of this application.

After the eigenvector is quantized and encoded, a corresponding code stream may be generated. Based on an experiment, high-quality compression can be implemented for a 32 kHz ultra-wideband signal through a bit rate of 6-10 kbps.

Therefore, in this embodiment of this application, down-sampling filtering is performed on the input signal to obtain the low-frequency signal. Because the low-frequency signal has more impact on audio encoding than the high-frequency signal in the audio signal, the low-frequency feature and the high-frequency feature of the input signal are respectively extracted through differential signal processing, so that the feature dimension of the high-frequency feature is lower than the feature dimension of the low-frequency feature, and the low-frequency feature and the high-frequency feature whose feature dimensions are reduced are respectively encoded, thereby improving audio encoding efficiency while ensuring audio quality.

The low rate NN encoding method provided in the embodiments of this application is described in detail below.

Following the foregoing examples, a procedure about the decoder side is as follows.

Operation 21: Perform quantization and decoding.

The quantization and the decoding are a reverse process of the quantitative and the encoding. Entropy decoding is first performed on the received code streams, to obtain index values corresponding to the code streams, and a quantization table is queried through the index values corresponding to the code streams, to obtain an estimated value F′_{LB}(n) of a low-frequency eigenvector and an estimated value F′_{HB}(n) of a high-frequency eigenvector.

Operation 22: Input the estimated value F′_{LB}(n) of the low-frequency eigenvector into a second NN.

Based on the estimated value F′_{LB}(n) of the low-frequency eigenvector, a second NN as shown in FIG. 11 is invoked, to generate an estimated value x′_{LB}(n) of a low-frequency signal.

The second NN is similar to the first NN, for example, the causal convolution. A post-processing structure in the second NN is similar to the preprocessing in the first NN. A structure of the decoding block is symmetrical to that of the encoding block on the encoder side. The encoding block on the encoder side first performs dilated convolution, and then performs pooling to complete down-sampling, while the decoding block on the decoder side first performs pooling to complete up-sampling and then performs dilated convolution.

Operation 23: Perform up-sampling filtering on the estimated value x′_{LB}(n) of the low-frequency signal.

A sampling rate of the generated estimated value x′_{LB}(n) of the low-frequency signal is only ½ of a sampling rate of the input signal x(n) on the encoder side. Therefore, up-sampling filtering needs to be performed on the estimated value x′_{LB}(n) of the low-frequency signal. the sampling rate is increased by 1 times, to generate an up-sampling signal xᵤₚ(n). Each frame xᵤₚ(n) includes 640 points. The up-sampling filtering in this embodiment of this application is equivalent to an up-sampling operation with a factor of 2.

Operation 24: Perform signal reconstruction through an up-sampling signal and the estimated value F′_{HB}(n) of the high-frequency eigenvector.

A first operation of the signal reconstruction is to obtain an obtained up-sampling signal xᵤₚ(n) to perform MDCT. Similar to the configuration of the encoder side, namely, the MDCT of 1280 points is calculated, and the MDCT coefficients of 640 points are obtained, i.e., Xᵤₚ(n). For example, for an up-sampling signal xᵤₚ(n) including 640 points, the MDCT is invoked, and a previous frame of up-sampling signal and this frame of up-sampling signal xᵤₚ(n) are combined, the MDCT of 1280 points are calculated, and the MDCT coefficients of 640 points are obtained. Because xᵤₚ(n) is an up-sampling signal form, only a part of content of 0-8 kHz is reserved for Xᵤₚ(n), and content of 8-16 kHz is missing.

A second operation of signal reconstruction is to invoke the band extension technology based on an estimated value F′_{HB}(n) of the obtained high-frequency eigenvector to generate a missing high-frequency component. F′_{HB}(n) is a sub-band spectral envelope of 8 high-frequency parts obtained through decoding in the code stream. Specific operations of the second operation of signal reconstruction are as follows.

Low-frequency MDCT coefficients (i.e., MDCT coefficients of first 320 points) in Xᵤₚ(n) are replicated, to generate reference values of MDCT coefficients of the high-frequency part. With reference to basic features of a voice signal, more harmonics exist in a low-frequency part, and fewer harmonics exist in a high-frequency part. Therefore, to avoid excessive harmonics in the artificially generated high-frequency MDCT spectrum caused by simple replication, last 160 points of the low-frequency MDCT coefficients in Xᵤₚ(n) are used as a master, and the spectrum is replicated 2 times, to generate reference values of the MDCT coefficients of 320 points of the high-frequency part signal (referred to as reference values of high-frequency MDCT coefficients for 320 points of the reference high-frequency signal for short). Low-frequency MDCT coefficients in Xᵤₚ(n) may also be used as the master, spectrum replication is performed 1 times, and reference values of the MDCT coefficients of 320 points of the high-frequency part signal are generated. Last 80 points of the low-frequency MDCT coefficients in Xᵤₚ(n) may also be used as the master, spectrum replication is performed 4 times, and the reference values of the MDCT coefficients of 320 points of the high-frequency part signal are generated. Therefore, after the spectrum replication, the last 320 points in Xᵤₚ(n) are non-zero coefficients.

Next, the foregoing obtained 8 sub-band spectral envelopes (i.e., an estimated value F′_{HB}(n) of a high-frequency eigenvector obtained by querying a quantization table) are invoked. The 8 sub-band spectral envelopes correspond to 8 high-frequency sub-bands, and the reference values of the MDCT coefficients of the 320 points of the generated high-frequency part signal are divided into 8 reference high-frequency sub-bands. Based on one high-frequency sub-band and a corresponding reference high-frequency sub-band, gain control (multiplication is performed in a frequency domain) is performed on the reference values of the MDCT coefficients of the 320 points of the high-frequency part signal. For example, a gain factor is calculated based on average energy of high-frequency sub-band and average energy of a corresponding reference high-frequency sub-band, and an MDCT coefficient corresponding to each point in the corresponding reference high-frequency sub-band is multiplied by the gain factor, to ensure that energy of a high-frequency MDCT coefficient generated virtually through decoding is close to original coefficient energy of the encoder side.

For example, it is assumed that the average energy of the reference high-frequency sub-band (i.e., the sub-band obtained by dividing the reference values of the MDCT coefficients of the 320 points of the generated high-frequency part signal) is Y_L, and average energy of a current high-frequency sub-band (i.e., a sub-band corresponding to a sub-band spectral envelope obtained by decoding based on a code stream) is Y_H, a gain factor a=sqrt(Y_H/Y_L) is calculated, sqrt() representing a square root calculation function configured for calculating a square root of (Y_H/Y_L). After the gain factor a is provided, an MDCT coefficient of each point in the reference high-frequency sub-band is directly multiplied by a. The average energy of the MDCT coefficients (generated virtually) on which the gain control is performed is excessively close to the original average energy on the encoder side.

Finally, MDCT inverse transformation is performed on the low-frequency MDCT coefficients in Xᵤₚ(n) (i.e., the MDCT coefficients of the first 320 points) and MDCT coefficients obtained after the gain control (i.e., the reference values of the MDCT coefficients of the last 320 points after gain in Xᵤₚ(n)), to generate estimated values of the MDCT of 1280 points. Through overlapping, estimated values of MDCT of the first 640 points that are valid are used as estimated values of the original input signal, i.e., the output signal x′(n).

Therefore, in this embodiment of this application, the received code streams (i.e. the low-frequency code stream and the high-frequency code stream) are decoded for the decoder side, to obtain the low-frequency eigenvector and the high-frequency eigenvector, and the inverse process of a corresponding encoder side is invoked for the low-frequency eigenvector, to complete reconstruction of the low-frequency part. Then, the reconstructed low-frequency part is restored to a sampling rate the same as that of the original inputted voice signal through up-sampling filtering. The high-frequency part is reconstructed by combining the low-frequency part and the high-frequency eigenvector obtained after up-sampling filtering, and the reconstructed low-frequency part and the high-frequency part are combined, to ensure that energy of the reconstructed high-frequency part is close to high-frequency energy on the encoder side. In this way, complete reconstruction of frequency domain coefficients from the low frequency to the high frequency is obtained.

In this embodiment of this application, related networks of the encoder side and the decoder side may be jointly trained by collecting data, to obtain an optimal parameter. The user only needs to prepare data and set a corresponding network structure, and can put the trained model into use after training is completed in the background.

Based on the above, according to the low-rate NN encoding and decoding method provided in the embodiments of this application, through an organic combination of a signal decomposition technology, a signal processing technology, and a deep NN, encoding efficiency is significantly improved compared with a signal processing solution when audio quality is ensured and complexity is acceptable.

In this case, the audio encoding method or audio decoding method provided in the embodiments of this application is described in combination with the exemplary application and the implementation of the terminal device provided in the embodiments of this application. The embodiments of this application further provide an audio encoding apparatus and an audio decoding apparatus. During actual application, various functional modules in the audio encoding apparatus and the audio decoding apparatus may be cooperatively implemented by a hardware resource of an electronic device (for example, a terminal device, a server, or a server cluster), a computing resource such as a processor, a communication resource (for example, configured to support implementation of various manners such as optical cable and cellular communications), and a memory. FIG. 3A shows the audio encoding apparatus 555 stored in the memory 550, and FIG. 3B shows the audio decoding apparatus 556 stored in the memory 550. The audio encoding apparatus and audio decoding apparatus may be software in a form such as a program and a plug-in, for example, an implementation such as a software module designed by a programming language such as software C/C++ or Java, an application software designed by a programming language such as C/C++ or Java, or a dedicated software module in a large software system, an application programming interface, a plug-in, and a cloud service. Different implementations are described by way of example below.

The audio encoding apparatus 555 includes a series of modules, including a down-sampling module 5551, a low-frequency extraction module 5552, a high-frequency analysis module 5553, and an encoding module 5554. A scheme of cooperatively implementing audio encoding by various modules in the audio encoding apparatus 555 according to the embodiments of this application continues to be described below.

The down-sampling module 5551 is configured to perform down-sampling processing on an audio signal to obtain a low-frequency signal of the audio signal. The low-frequency extraction module 5552 is configured to perform low-frequency feature extraction processing on the low-frequency signal to obtain a low-frequency feature of the audio signal. The high-frequency analysis module 5553 is configured to perform high-frequency analysis processing on the audio signal to obtain a high-frequency feature of the audio signal, a feature dimension of the high-frequency feature being lower than a feature dimension of the low-frequency feature. The encoding module 5554 is configured to perform encoding processing on the low-frequency feature to obtain a low-frequency code stream of the audio signal, and perform encoding processing on the high-frequency feature to obtain a high-frequency code stream of the audio signal.

In some embodiments, the audio signal includes a plurality of first sample points obtained through sampling. The down-sampling module 5551 is further configured to perform down-sampling processing on each of the first sampling points included in the audio signal through a down-sampling filter, to obtain the low-frequency signal of the audio signal.

In some embodiments, the down-sampling module 5551 is further configured to perform the following processing through the down-sampling filter: performing digital signal-based filtering processing on the sampling point included in the audio signal, to obtain a filtered audio signal; and performing digital signal-based down-sampling processing on the filtered audio signal, to obtain the low-frequency signal of the audio signal.

In some embodiments, the low-frequency extraction module 5552 is further configured to perform convolution processing on the low-frequency signal to obtain a convolution feature of the low-frequency signal; perform pooling processing on the convolution feature to obtain a pooling feature of the low-frequency signal; perform down-sampling processing on the pooling feature to obtain a down-sampling feature of the low-frequency signal; and perform convolution processing on the down-sampling feature to obtain the low-frequency feature of the audio signal.

In some embodiments, the down-sampling processing is implemented through a plurality of cascaded encoding layers. The low-frequency extraction module 5552 is further configured to: perform down-sampling processing on the pooling feature through a first encoding layer in the plurality of cascaded encoding layers; output a down-sampling result of the first encoding layer to a subsequent cascaded encoding layer, and further perform down-sampling processing and the outputting of the down-sampling result through the subsequent cascaded encoding layer until the down-sampling result is outputted to a last encoding layer; and determine a down-sampling result outputted by the last encoding layer as the down-sampling feature of the low-frequency signal.

In some embodiments, the high-frequency analysis module 5553 is further configured to perform band extension processing on the audio signal to obtain the high-frequency feature of the audio signal.

In some embodiments, the high-frequency analysis module 5553 is further configured to: perform frequency domain transformation processing on a plurality of second sample points included in the audio signal, to obtain transformation coefficients respectively corresponding to the plurality of second sample points; divide high-frequency transformation coefficients in the transformation coefficients respectively corresponding to the plurality of second sample points into a plurality of sub-bands; perform averaging processing on the transformation coefficient included in each of the sub-bands, to obtain average energy corresponding to each sub-band, and determine the average energy as a sub-band spectral envelope corresponding to each sub-band; and determine the sub-band spectral envelopes respectively corresponding to the plurality of sub-bands as the high-frequency feature of the audio signal.

In some embodiments, the high-frequency analysis module 5553 is further configured to: obtain a plurality of third sample points included in a reference audio signal, the reference audio signal being an audio signal adjacent to the audio signal; and perform, based on the plurality of third sample points included in the reference audio signal and the plurality of second sample points included in the audio signal, discrete cosine transformation processing on the plurality of second sample points included in the audio signal, to obtain transformation coefficients respectively corresponding to the plurality of second sample points.

In some embodiments, the high-frequency analysis module 5553 is further configured to: determine a quadratic sum of transformation coefficients corresponding to the second sample points included in each sub-band; and determine, as the average energy corresponding to each sub-band, a ratio of the quadratic sum to a quantity of second sample points included in the sub-band.

The audio decoding apparatus 556 includes a series of modules, including a decoding module 5561, a low-frequency reconstruction module 5562, an up-sampling module 5563, and a signal reconstruction module 5564. A scheme of cooperatively implementing audio decoding by various modules in the audio decoding apparatus 555 according to the embodiments of this application continues to be described below.

The decoding module 5561 is configured to perform decoding processing on a low-frequency code stream of an audio signal to obtain a low-frequency feature corresponding to the low-frequency code stream, and perform decoding processing on a high-frequency code stream of the audio signal to obtain a high-frequency feature corresponding to the high-frequency code stream, the low-frequency code stream being obtained by encoding a low-frequency signal obtained through down-sampling of the audio signal, and a feature dimension of the high-frequency feature being lower than a feature dimension of the low-frequency feature. The low-frequency reconstruction module 5562 is configured to perform low-frequency feature reconstruction processing on the low-frequency feature to obtain a low-frequency signal corresponding to the low-frequency feature. The up-sampling module 5563 is configured to perform up-sampling processing on the low-frequency signal to obtain an up-sampling signal of the low-frequency signal. The signal reconstruction module 5564 is configured to perform signal reconstruction processing on the high-frequency feature and the up-sampling signal to obtain a synthesized audio signal corresponding to the low-frequency code stream and the high-frequency code stream.

In some embodiments, the audio signal includes a plurality of fourth sample points obtained through sampling. The up-sampling module 5563 is further configured to perform up-sampling processing on a fourth sampling point included in the low-frequency signal through an up-sampling filter, to obtain the up-sampling signal of the low-frequency signal.

In some embodiments, the up-sampling module 5563 is further configured to perform the following processing through the up-sampling filter: performing digital signal-based up-sampling processing on the fourth sampling point included in the low-frequency signal, to obtain an up-sampled low-frequency signal; and performing digital signal-based filtering processing on the up-sampled low-frequency signal to obtain an up-sampling signal of the low-frequency signal.

In some embodiments, the low-frequency reconstruction module 5562 is further configured to: perform convolution processing on the low-frequency feature to obtain a convolution feature of the low-frequency feature; perform up-sampling processing on the convolution feature to obtain an up-sampling feature of the low-frequency feature; perform pooling processing on the up-sampling feature to obtain a pooling feature of the low-frequency feature; and perform convolution processing on the pooling feature to obtain the low-frequency signal corresponding to the low-frequency feature.

In some embodiments, the up-sampling processing is implemented through a plurality of cascaded decoding layers. The low-frequency reconstruction module 5562 is further configured to: perform up-sampling processing on the convolution feature through a first decoding layer in the plurality of cascaded decoding layers; output an up-sampling result of the first decoding layer to a subsequent cascaded decoding layer, and further perform up-sampling processing and the outputting of the up-sampling result through the subsequent cascaded decoding layer until the up-sampling result is outputted to a last decoding layer; and determine an up-sampling result outputted by the last decoding layer as the up-sampling feature of the low-frequency feature.

In some embodiments, the signal reconstruction module 5564 is further configured to: perform frequency domain transformation processing on a plurality of fifth sample points included in the up-sampling signal, to obtain transformation coefficients respectively corresponding to the plurality of fifth sample points; perform band extension processing on the transformation coefficients respectively corresponding to the plurality of fifth sample points and the high-frequency feature, to obtain a high-frequency transformation coefficient of a high-frequency signal; and determine the synthesized audio signal corresponding to the low-frequency code stream and the high-frequency code stream based on the high-frequency transformation coefficient and transformation coefficients respectively corresponding to some of the plurality of fifth sample points.

In some embodiments, the signal reconstruction module 5564 is further configured to: perform spectrum replication processing on at least part of the transformation coefficients in a first half of the transformation coefficients respectively corresponding to the plurality of fifth sample points, to obtain a reference high-frequency transformation coefficient of a reference high-frequency signal; and perform gain processing on the reference high-frequency transformation coefficient of the reference high-frequency signal based on a sub-band spectral envelope corresponding to the high-frequency feature, to obtain the high-frequency transformation coefficient of the high-frequency signal.

In some embodiments, the signal reconstruction module 5564 is further configured to: divide the reference high-frequency transformation coefficient of the reference high-frequency signal into a plurality of sub-bands based on the sub-band spectral envelope corresponding to the high-frequency feature; and perform the following processing for any one of the plurality of sub-bands. Determining first average energy of a high-frequency sub-band corresponding to the sub-band in the sub-band spectral envelope, and determining second average energy of the sub-band; determining a gain factor based on a ratio of the first average energy to the second average energy; multiplying the gain factor by each reference high-frequency transformation coefficient included in the sub-band, to obtain a high-frequency transformation coefficient corresponding to the sub-band; and determining the high-frequency transformation coefficient corresponding to each of the plurality of sub-bands as the high-frequency transformation coefficients of the high-frequency signal.

In some embodiments, the signal reconstruction module 5564 is further configured to perform spectrum replication processing on a second half of the transformation coefficients in a first half of the transformation coefficients respectively corresponding to the plurality of fifth sample points, to obtain a reference high-frequency transformation coefficient of a reference high-frequency signal.

In some embodiments, the signal reconstruction module 5564 is further configured to: perform combining processing on the high-frequency transformation coefficient and transformation coefficients respectively corresponding to a first half of fifth sample points in the plurality of fifth sample points, to obtain a complete transformation coefficient; and perform inverse transformation processing of spectrum transformation on the complete transformation coefficient, to obtain the synthesized audio signal corresponding to the low-frequency code stream and the high-frequency code stream.

An embodiment of this application provides a computer program product, the computer program product including a computer program or a computer-executable instruction, the computer program or the computer-executable instruction being stored in a non-transitory computer-readable storage medium. A processor of an electronic device reads the computer program or the computer-executable instruction from the computer-readable storage medium, and the processor executes the computer program or the computer-executable instruction, so that the electronic device performs the foregoing audio encoding method or audio decoding method in the embodiments of this application.

An embodiment of this application provides a non-transitory computer-readable storage medium storing a computer-executable instruction stored, having a computer-executable instruction or a computer program stored therein, the computer-executable instruction or the computer program, when executed by a processor, causing the processor to perform the audio encoding method or the audio decoding method provided in the embodiments of this application, for example, the audio encoding method shown in FIG. 6A to FIG. 6D and the audio decoding method shown in FIG. 7A to FIG. 7D.

In some embodiments, the computer-readable storage medium may be a memory such as a ferromagnetic random access memory (FRAM), a ROM, a programmable random access memory (PROM), an erasable programmable random access memory (EPROM), an electrically erasable programmable random access memory (EEPROM), a flash memory, a magnetic surface memory, a compact disc, or a compact disc random access memory (CD-ROM), or may be various devices including one of or any combination of the foregoing memories.

In some embodiments, the computer-executable instruction may be written in any form of a programming language (including a compiled or interpreted language, or a declarative or procedural language) in the form of a program, software, a software module, a script, or code, and may be deployed in any form, which may be deployed as a standalone program or as a module, components, a subroutine, or another unit suitable for use in a computing environment.

In an example, the computer-executable instruction may but may not necessarily correspond to a file in a file system, may be stored in a part of the file for storing other programs or data, for example, stored in one or more scripts in a hypertext markup language (HTML) document, stored in a single file specially used for the discussed program, or stored in a plurality of collaborative files (for example, files storing one or more modules, a subprogram, or a code part).

In an example, the computer-executable instruction may be deployed to be executed on one electronic device, or executed on a plurality of electronic devices located at one location, or executed on a plurality of electronic devices distributed at a plurality of locations and connected through a communication network.

The embodiments of this application relate to related data such as user information. User permission or consent needs to be obtained when the embodiments of this application are applied to specific products or technologies, and collection, use, and processing of related data need to comply with relevant laws, regulations, and standards of relevant countries and regions.

In this application, the term “module” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each module can be implemented using one or more processors (or processors and memory). Likewise, a processor (or processors and memory) can be used to implement one or more modules. Moreover, each module can be part of an overall module that includes the functionalities of the module. The foregoing descriptions are merely embodiments of this application and are not intended to limit the protection scope of this application. Any modification, equivalent replacement, or improvement made within the spirit and principle of this application falls within the protection scope of this application.

What is claimed is:

1. An audio encoding method comprising:
performing down-sampling on an audio signal to obtain a low-frequency signal of the audio signal;
performing low-frequency feature extraction on the low-frequency signal to obtain a low-frequency feature of the audio signal;
performing high-frequency analysis on the audio signal to obtain a high-frequency feature of the audio signal;
performing encoding on the low-frequency feature and the high-frequency feature separately to obtain a low-frequency code stream of the audio signal and a high-frequency code stream of the audio signal; and
transmitting the low-frequency code stream of the audio signal and the high-frequency code stream of the audio signal to a second electronic device via a computer network.

2. The method according to claim 1, wherein the performing down-sampling on the audio signal comprises:
performing down-sampling on each of a plurality of first sampling points comprised in the audio signal through a down-sampling filter, to obtain the low-frequency signal of the audio signal.

3. The method according to claim 2, wherein the performing down-sampling on each of the plurality of first sampling points comprised in the audio signal comprises:
performing digital signal-based filtering on the plurality of first sampling point comprised in the audio signal, to obtain a filtered audio signal; and
performing digital signal-based down-sampling on the filtered audio signal, to obtain the low-frequency signal of the audio signal.

4. The method according to claim 1, wherein the performing low-frequency feature extraction on the low-frequency signal to obtain the low-frequency feature of the audio signal comprises:
performing convolution on the low-frequency signal to obtain a convolution feature of the low-frequency signal;
performing pooling on the convolution feature to obtain a pooling feature of the low-frequency signal;
performing down-sampling on the pooling feature to obtain a down-sampling feature of the low-frequency signal; and
performing convolution on the down-sampling feature to obtain the low-frequency feature of the audio signal.

5. The method according to claim 4, wherein the performing down-sampling on the pooling feature to obtain a down-sampling feature of the low-frequency signal comprises:
performing down-sampling processing on the pooling feature through a first encoding layer in a plurality of cascaded encoding layers;
outputting a down-sampling result of the first encoding layer to a subsequent cascaded encoding layer, and further performing down-sampling processing and the outputting of the down-sampling result through the subsequent cascaded encoding layer until the down-sampling result is outputted to a last encoding layer; and
determining a down-sampling result outputted by the last encoding layer as the down-sampling feature of the low-frequency signal.

6. The method according to claim 1, wherein the performing high-frequency analysis on the audio signal to obtain the high-frequency feature of the audio signal comprises:
performing band extension on the audio signal to obtain the high-frequency feature of the audio signal.

7. The method according to claim 6, wherein the performing band extension on the audio signal to obtain the high-frequency feature of the audio signal comprises:
performing frequency domain processing on a plurality of second sample points comprised in the audio signal, to obtain transformation coefficients respectively corresponding to the plurality of second sample points;
dividing high-frequency transformation coefficients in the transformation coefficients respectively corresponding to the plurality of second sample points into a plurality of sub-bands;
averaging the transformation coefficient comprised in each of the sub-bands, to obtain average energy corresponding to each sub-band, and determining the average energy as a sub-band spectral envelope corresponding to each sub-band; and
determining the sub-band spectral envelopes respectively corresponding to the plurality of sub-bands as the high-frequency feature of the audio signal.

8. The method according to claim 1, wherein a feature dimension of the high-frequency feature is lower than a feature dimension of the low-frequency feature.

9. An electronic device, comprising:
a memory, configured to store a computer program; and
a processor, configured to implement an audio encoding method when executing the computer program, the method including:
performing down-sampling on an audio signal to obtain a low-frequency signal of the audio signal;
performing low-frequency feature extraction on the low-frequency signal to obtain a low-frequency feature of the audio signal;
performing high-frequency analysis on the audio signal to obtain a high-frequency feature of the audio signal;
performing encoding on the low-frequency feature and the high-frequency feature separately to obtain a low-frequency code stream of the audio signal and a high-frequency code stream of the audio signal; and
transmitting the low-frequency code stream of the audio signal and the high-frequency code stream of the audio signal to a second electronic device via a computer network.

10. The electronic device according to claim 9, wherein the performing down-sampling on the audio signal comprises:
performing down-sampling on each of a plurality of first sampling points comprised in the audio signal through a down-sampling filter, to obtain the low-frequency signal of the audio signal.

11. The electronic device according to claim 10, wherein the performing down-sampling on each of the plurality of first sampling points comprised in the audio signal comprises:
performing digital signal-based filtering on the plurality of first sampling point comprised in the audio signal, to obtain a filtered audio signal; and
performing digital signal-based down-sampling on the filtered audio signal, to obtain the low-frequency signal of the audio signal.

12. The electronic device according to claim 9, wherein the performing low-frequency feature extraction on the low-frequency signal to obtain the low-frequency feature of the audio signal comprises:
performing convolution on the low-frequency signal to obtain a convolution feature of the low-frequency signal;
performing pooling on the convolution feature to obtain a pooling feature of the low-frequency signal;
performing down-sampling on the pooling feature to obtain a down-sampling feature of the low-frequency signal; and
performing convolution on the down-sampling feature to obtain the low-frequency feature of the audio signal.

13. The electronic device according to claim 12, wherein the performing down-sampling on the pooling feature to obtain a down-sampling feature of the low-frequency signal comprises:
performing down-sampling processing on the pooling feature through a first encoding layer in a plurality of cascaded encoding layers;
outputting a down-sampling result of the first encoding layer to a subsequent cascaded encoding layer, and further performing down-sampling processing and the outputting of the down-sampling result through the subsequent cascaded encoding layer until the down-sampling result is outputted to a last encoding layer; and
determining a down-sampling result outputted by the last encoding layer as the down-sampling feature of the low-frequency signal.

14. The electronic device according to claim 9, wherein the performing high-frequency analysis on the audio signal to obtain the high-frequency feature of the audio signal comprises:
performing band extension on the audio signal to obtain the high-frequency feature of the audio signal.

15. The electronic device according to claim 14, wherein the performing band extension on the audio signal to obtain the high-frequency feature of the audio signal comprises:
performing frequency domain processing on a plurality of second sample points comprised in the audio signal, to obtain transformation coefficients respectively corresponding to the plurality of second sample points;
dividing high-frequency transformation coefficients in the transformation coefficients respectively corresponding to the plurality of second sample points into a plurality of sub-bands;
averaging the transformation coefficient comprised in each of the sub-bands, to obtain average energy corresponding to each sub-band, and determining the average energy as a sub-band spectral envelope corresponding to each sub-band; and
determining the sub-band spectral envelopes respectively corresponding to the plurality of sub-bands as the high-frequency feature of the audio signal.

16. The electronic device according to claim 9, wherein a feature dimension of the high-frequency feature is lower than a feature dimension of the low-frequency feature.

17. A non-transitory computer-readable storage medium storing a video bitstream that is generated by an audio encoding method, the audio encoding method including:
performing down-sampling on an audio signal to obtain a low-frequency signal of the audio signal;
performing low-frequency feature extraction on the low-frequency signal to obtain a low-frequency feature of the audio signal;
performing high-frequency analysis on the audio signal to obtain a high-frequency feature of the audio signal;
performing encoding on the low-frequency feature and the high-frequency feature separately to obtain a low-frequency code stream of the audio signal and a high-frequency code stream of the audio signal; and
transmitting the low-frequency code stream of the audio signal and the high-frequency code stream of the audio signal to a second electronic device via a computer network.

18. The non-transitory computer-readable storage medium according to claim 17, wherein the performing down-sampling on the audio signal comprises:
performing down-sampling on each of a plurality of first sampling points comprised in the audio signal through a down-sampling filter, to obtain the low-frequency signal of the audio signal.

19. The non-transitory computer-readable storage medium according to claim 17, wherein the performing low-frequency feature extraction on the low-frequency signal to obtain the low-frequency feature of the audio signal comprises:
performing convolution on the low-frequency signal to obtain a convolution feature of the low-frequency signal;
performing pooling on the convolution feature to obtain a pooling feature of the low-frequency signal;
performing down-sampling on the pooling feature to obtain a down-sampling feature of the low-frequency signal; and
performing convolution on the down-sampling feature to obtain the low-frequency feature of the audio signal.

20. The non-transitory computer-readable storage medium according to claim 17, wherein the performing high-frequency analysis on the audio signal to obtain the high-frequency feature of the audio signal comprises:
performing band extension on the audio signal to obtain the high-frequency feature of the audio signal.
